(19) United States
(12) Patent Application Publication
(10) Pub. No.: US 2012/0092107 A1
(43) Pub. Date: Apr. 19, 2012

(54) PROPULSION SYSTEM USING THE ANTIGRAVITY FORCE OF THE VACUUM AND APPLICATIONS

(76) Inventor: Alexandre Tiago Baptista De Alves Martins, Lisboa (PT)

(21) Appl. No.: 13/380,202

(22) PCT Filed: Jun. 22, 2010
(86) PCT No.: PCT/PT2010/000025

§ 371 Date: Dec. 22, 2011

(30) Foreign Application Priority Data
Jun. 22, 2009 (PT) 104638

(51) Int. Cl. H01F 7/02

(52) U.S. Cl. 335/306

(57) ABSTRACT

A propulsion system for aerial, terrestrial, underwater or space propulsion, achieved through the manipulation (or engineering) of the vacuum with the proper electromagnetic interactions. This vacuum manipulation will allow the use of a new form of propulsion, and has applications in energy production and on the change of the time decay of radioactive elements. Opposing magnetic or electric fields create a mass repelling force, while attracting magnetic or electric fields create a mass attracting force. In particular, this vacuum manipulation process can be used to propel a mass that contains the field sources that perturb the vacuum. One possible application is the creation of a repulsion point in space through the interference of two or more longitudinal electrodynamic wave beams, which cause a repulsion force on the mass.

The present invention relates to a new form of aerial, terrestrial, underwater or space propulsion, achieved through the manipulation (or engineering) of the vacuum with the proper electromagnetic interactions. This vacuum manipulation will allow the use of a new form of propulsion, and has applications in energy production and on the change of the time decay of radioactive elements. In order to better understand the workings of this invention, we will first supply the underlying theory that made possible this innovation.

Usually science describes the four fundamental forces as:
1—Electromagnetic force
2—Gravitational force
3—Nuclear strong force
4—Nuclear weak force

This is an incomplete list since it has already been proven that there exists one additional fundamental force: Antigravity. This force was discovered by astrophysicists in 1998 in the sequence of astronomical observations that could only be explained if this new force existed (Glanz, 1998). Thus, the existence of this force has been verified by direct observation. It is generated by the vacuum itself due to its state of high stress.

The antigravity force of the vacuum is well known in Astronomical circles (Grön, 1986, 2009; Magueijo, 2003). The state of stress in the vacuum is usually described with the analogy of two forces pulling in opposite directions and therefore generating a stress. As it is known, according to the Heisenberg uncertainty principle, there are always electromagnetic waves being created and destroyed in the vacuum of space. These electromagnetic oscillations are always created by pairs in opposition, in such a way that the vacuum shows zero net energy. This fact is usually described as the potential source of an enormous quantity of energy. The vacuum looks like it doesn't have any energy because the electromagnetic waves that it generates are all phase cancelled by other waves in such a way that the final observable result is zero, remaining no observable energy to see. However, the vacuum possesses, at any time, an incredible quantity of electromagnetic fields in opposition and this is the source of its density and high stress or tension.

According to Grön (1986) the gravitational mass of the vacuum is negative. The total density of gravitational mass ρ_{G} is given by:

ρ_{G}=T₀⁰−T₁¹−T₂²−T₃³. (1)

The term on the right represents the components of the energy-momentum density tensor, where T₀⁰ is the energy density and T₁¹, T₂² and T₃³ are stress components. The energy density is always positive but the stress components can be positive or negative; Tᵢⁱ<0, i=1, 2, 3 corresponds to compressed states or a positive pressure, Tᵢⁱ>0 corresponds to stretched states or a negative pressure.

Equation (1) shows that systems with an extremely large negative pressure or positive tension can have negative gravitational mass density. Generally, a high negative pressure or stretched state will produce a gravitational repulsion force. On the other hand, a positive pressure or compressed state will produce a gravitational attractive force.

According to the Friedman models of the universe, which are solutions of Einstein's field equations describing an expanding isotropic universe filled with perfect fluid, the fluid (vacuum) is described by an energy-momentum tensor of the form (Grön and Hervik, 2007; Grön, 2009):

$${T}_{μ v} = ( ρ + \frac{p}{{c}^{2}} ) {u}_{μ} {u}_{v} + {pg}_{μ v} . \qquad ( 2 )$$

However, considering a vacuum polarization as a gas of virtual particles, Grön (1986, 2009) and Grön and Hervik (2007) showed that the energy-momentum density tensor of the vacuum as a dominating term of the form:

T_{μν}=pg_{μν}=−ρc₂g_{μν}. (3)

Where the energy density ρ of the vacuum appears as a cosmological constant, p is the pressure, and both imply the equation of state: p=−pc², where c is the velocity of light. Since in hydrodynamic terms the pressure is given by: p=−τ, where τ is the tension; the vacuum is in a state of extreme tension because its pressure is large and negative due to having a high density ρ, and also due to the multiplying factor of c². This is the reason behind the experimentally observed antigravity force of the vacuum observed by a team of astronomers (Glanz, 1998). A tense vacuum will have a tendency to expand under the action of its own repulsive gravitation. On the other hand, radiation and mass in space will have a positive gravitational mass that will favor space contraction.

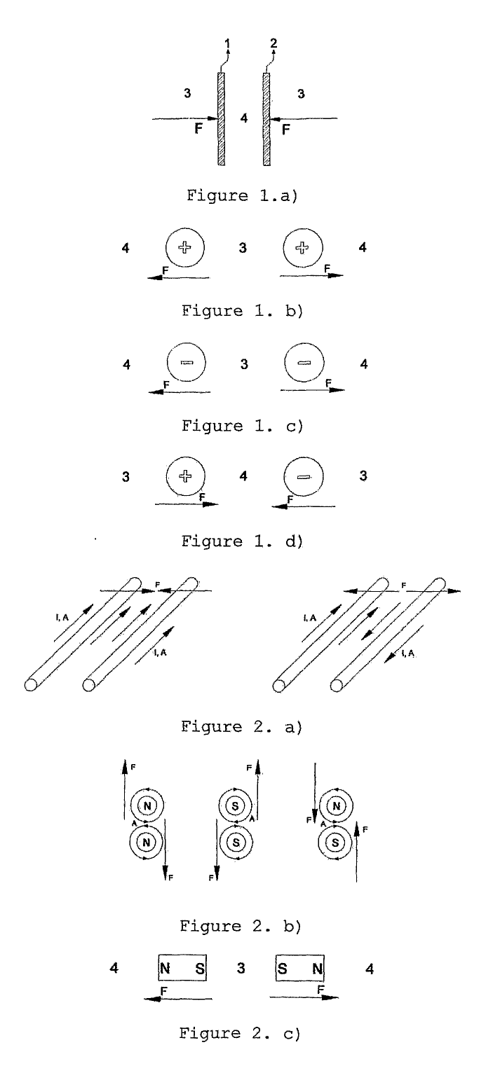

In the Casimir effect, some of the electromagnetic vacuum propagating modes (which are in opposition by pairs) are eliminated between two metallic plates (1 and 2) that are very near (FIG. 1.a), where 3 represents a high vacuum density and 4 represents a low vacuum density). Between the plates the vacuum density will be less than outside, and therefore the vacuum will also be less tense. The tenser vacuum that exists outside the plates will push them together, due to the negative gravitational properties of the vacuum as evidenced by equation (1). This is a simple effect, experimentally proven by Lamoreaux (1997) and one can gain extremely useful insights from it, such as a better understanding of the origin of gravity and electromagnetic forces.

Electromagnetic forces can be explained by the vacuum stresses they produce. This is being developed in a new theory called “Fluidic. Electrodynamics” which interprets all electromagnetic forces in terms of fluid hydrodynamics and a perfect fluid and tense vacuum. The nuts and bolts of this theory are not yet published in order to secure a patent for the resultant spinoffs before publication. Basically, this theory shows parallels between the equations of electromagnetism and hydrodynamics in such a way that it allows electromagnetic forces to be interpreted as having a hydrodynamic origin from the vacuum itself. In this case, the vacuum is treated like a perfect fluid (Grön, 1986, 2009). Besides the interesting hydrodynamic analogy, the physical origin of the electromagnetic forces resides on the way electric charges and magnetic interactions alter the stress or tension of the vacuum in such a way to generate attraction or repulsion forces.

Let's consider two positive charges. The oppositely directed or canceling electric field between the positive charges will increase the vacuum density and stress between them. Because the vacuum is tenser between the charges, the antigravity force generated by the vacuum in that region will force the two particles apart. This explains the physical origin of the repulsion force between equal sign charges (FIGS. 1.b) and 1.c), where the + signs represent positive charges and the − signs represent negative charges).

As we will see, electromagnetic forces and gravity can be perfectly explained by the antigravity force generated by stresses in, the vacuum. The gradient of the vacuum stresses will determine the direction of the observed forces. These vacuum forces will always be repulsive. Attraction and repulsion will depend on the resultant vector of the total repulsive forces.

If we consider a positive and a negative charge, we can see that the electric field is increased between the charges and therefore the vacuum stress and antigravity force of the vacuum is lower between, the charges than outside. In this case the charges will be impelled towards each other by this vacuum stress gradient (FIG. 1.d)).

A moving charge generates a magnetic vector potential in its direction of movement. This vector potential is equivalent to the hydrodynamic velocity of the vacuum (Maxwell, 1861). Magnetic forces can easily be explained in hydrodynamic terms has interactions of the generated vector potentials. Hydrodynamic currents attract if they are in the same direction and repel if they are in opposite directions. In this way, the attraction and repulsion force between currents and magnets can be explained in hydrodynamic terms. On a more fundamental level, this force can be attributed to how the (interacting) vector potentials alter the vacuum stresses.

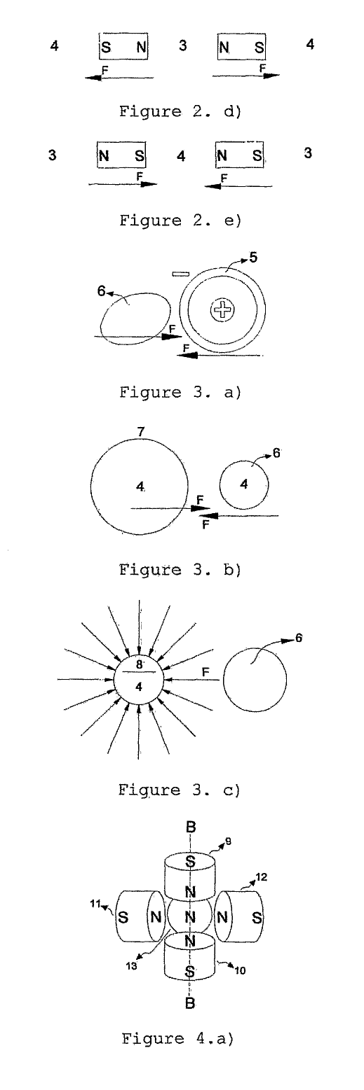

The magnetic vector potential A is always in the direction of the current I. In the case of two (steady state) parallel currents in the same direction, the vector potential of both currents is in the same direction (is not opposed). This will lower the vacuum density and tension between the two currents, generating an attraction force because the vacuum density is higher outside the currents (FIG. 2.a) on the left side). If the currents are parallel but in opposite directions, then the vector potential will tend to cancel between the currents, due to the oppositely directed vectors. This oppositely directed field will increase the vacuum density and tension between the currents and the vacuum antigravity force generated between them will be higher than outside, therefore the currents will repel each other (FIG. 2.a) on the right side). This explanation is also valid for magnets, since they have “equivalent surface currents” that generate the vector potentials and corresponding magnetic fields (FIGS. 2.b) to 2.e), where N and S represent, respectively, the magnetic north and south poles, and A represents the magnetic vector potential). This forms a physical basis for the interpretation of magnetic forces in terms of vacuum stresses (FIG. 2).

The important point here is that electromagnetic forces alter the state of tension of the vacuum which is reflected as attraction or repulsion, according to the vacuum density (tension) gradient. On this stance, the gravitational force can be attributed to vacuum stresses as well. We just have to look at how matter is made. It contains a concentration of positive charge in the center surrounded by circulating electrons with negative charge. This represents two concentrations of opposite charges in space that act like a “capacitor” (FIG. 3. a), where 5 represents a simplified atom, and 6 represents a mass agglomerate). If we reconsider the earlier explanation for the electrostatic forces we see that attracting charges diminish the local vacuum stress (tension) between them. Therefore, atoms will electrically induce a lower vacuum density inside their structure, generating an attracting gravitational force towards them due to the surrounding vacuum stress gradient (FIG. 3.b), where 7 represents the mass of the Earth). The lower vacuum density in atoms also implies the existence of less electromagnetic allowed states, like also observed in the Casimir effect experiment, that are known to exist for the electrons that surround the nucleus. Atoms also contain opposing magnetic fields from the spin and movement of the charged particles that are responsible for the slight decrease in weight observed between an atom and its individual constituents. This happens because the opposing magnetism in atoms increases the vacuum stress but since magnetism has a much lower strength, in this case, than the existing electric fields, an attraction force towards atoms will be the resulting force.

It is known that a plasma does not allow the propagation of electromagnetic waves until a certain cutoff frequency is surpassed that depends on the plasma density and thickness (Laroussi and Anderson, 1998). Therefore, the plasma is doing exactly what the parallel conductor plates in the Casimir effect did (FIG. 1.a)). The vacuum density inside the plasma will also be lower, and it will induce a force on a nearby mass towards the plasma because of the vacuum stress gradient. This means that if we create a very high density plasma 8 (density and thickness have to be optimized), we will generate a very strong gravitational pull towards this plasma (FIG. 3.c)). The plasma gravitational pull can be easily understood if we note that the plasma is made of a very high density charge concentration of both polarities. And, as explained in relation to FIG. 1.d), attracting charges induce a low vacuum density between them.

Until now, the theory presented here could explain in simple terms the physical origin of electromagnetic and gravitational forces. They all derive from gradient stresses in the vacuum created by opposing or non-opposing electromagnetic fields. There exists a simple experiment that proves further the gravitational connection between vacuum stresses and electromagnetic interactions. This experiment was initially mentioned by Boyd Bushman (personal communication), a retired engineer from Lockheed Martin. He repeated Galileo's experiment of dropping two masses side by side and measured the time they took to fall. Boyd verified that when we drop two opposing magnets in one container and normal matter in a second container (of equal geometry), the opposing magnets arrived latter than the normal mass. This experiment violates the equivalence principle and proves the relation between opposing fields, vacuum stresses and gravitational interactions. It can be easily verified by dropping opposing magnets trough coils connected to an oscilloscope, and then measure the falling time and compare to the falling time of simple magnets. The basic theory presented until this point will be the basis for the experimental ideas in antigravity propulsion proposed henceforth.

The present invention will now be described in detail, without a limited character and using preferred examples, presented in the accompanying drawings, where:

FIG. 1 depicts how conducting plates and electric charges alter the vacuum stress and induce mechanical forces.

FIG. 2 depicts how magnetic forces alter the vacuum stress and induce mechanical forces.

FIG. 3 depicts the origin of gravitational forces from vacuum stress gradients.

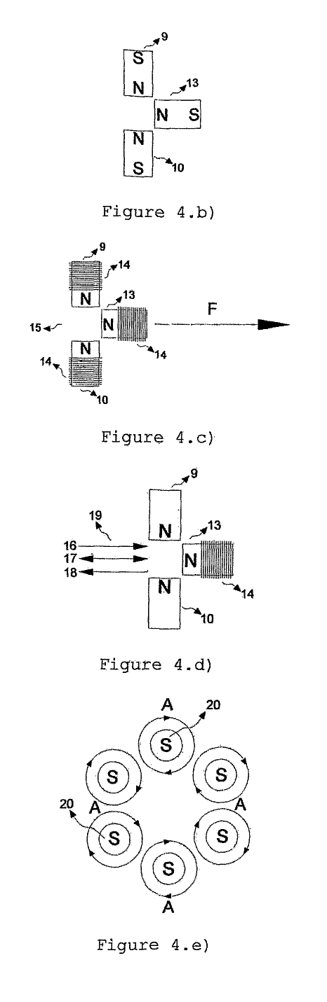

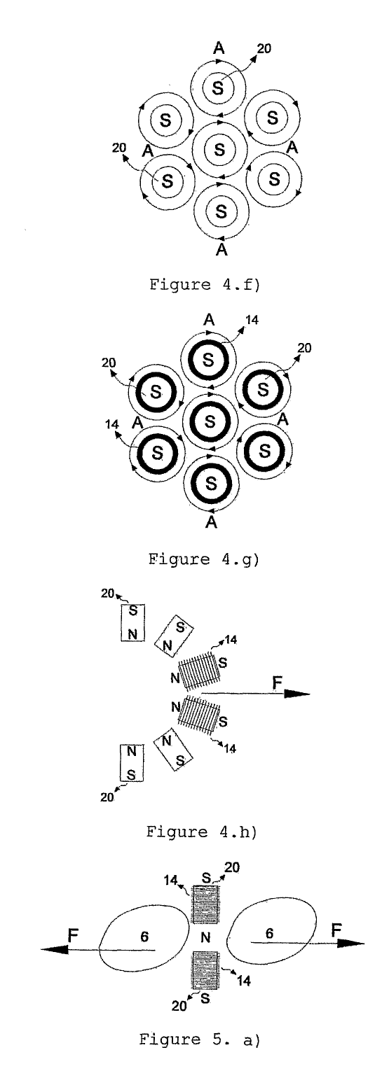

FIG. 4 depicts the first embodiment of this invention, based on opposing magnets.

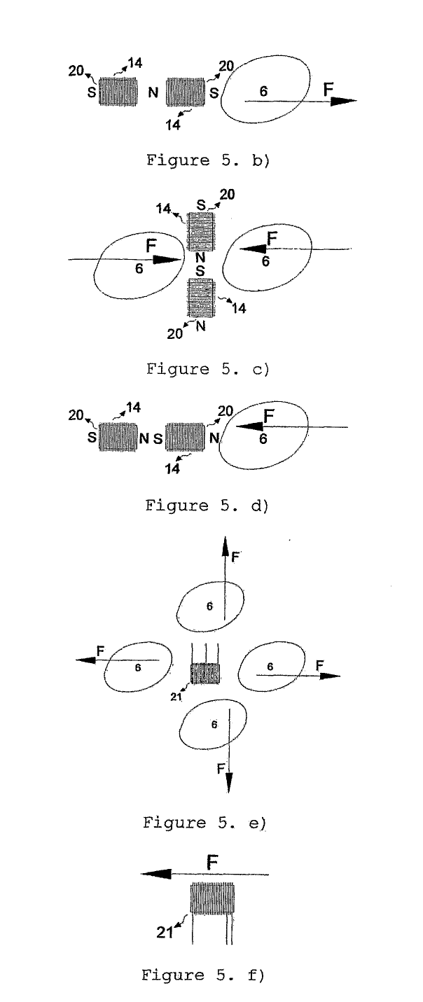

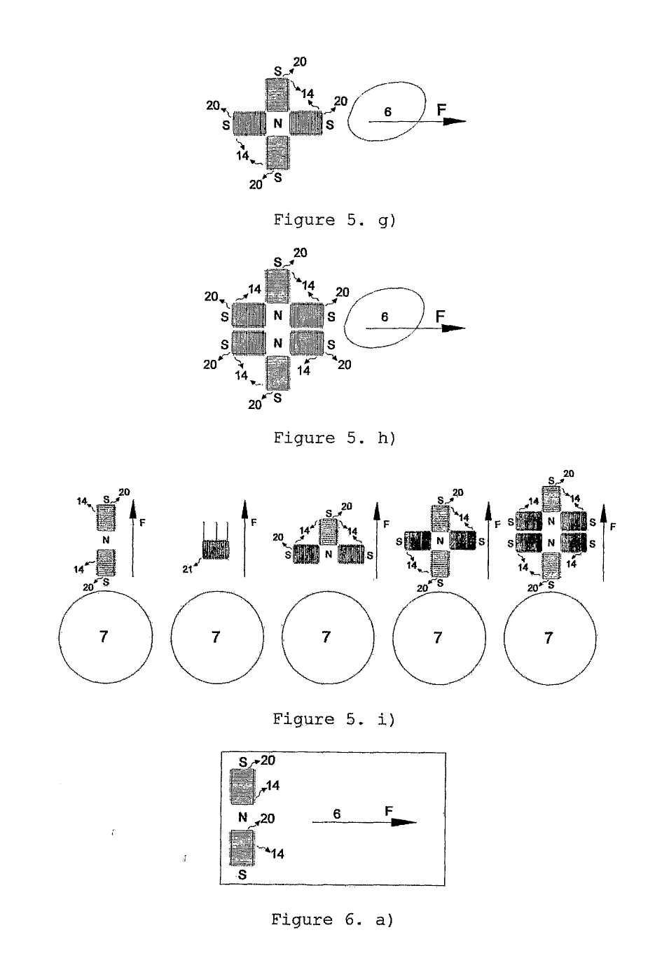

FIG. 5 depicts an embodiment where several arrangements of opposing magnetic vector potentials are shown to induce mechanical forces on surrounding masses.

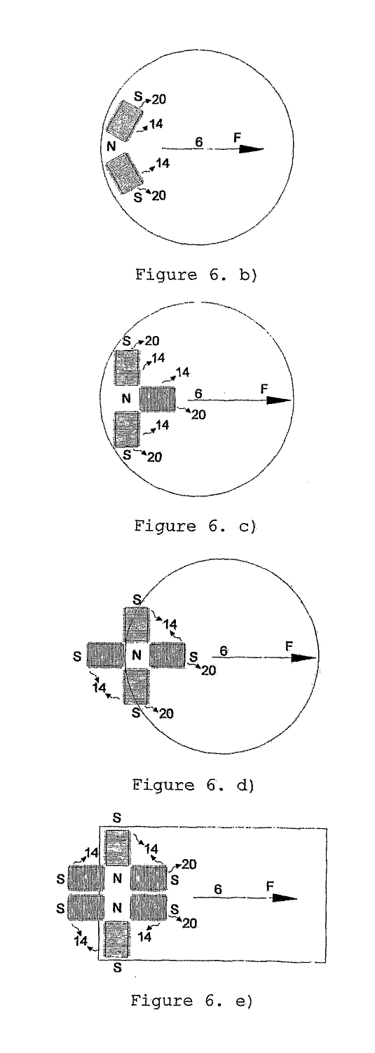

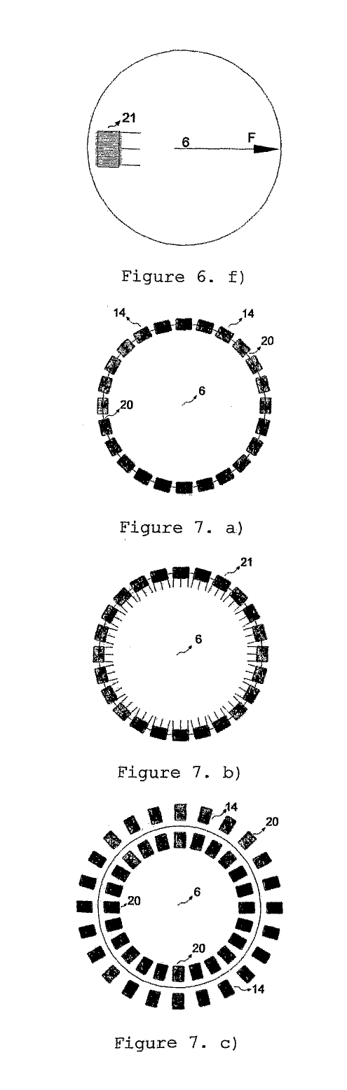

FIG. 6 depicts several units with opposing magnetic vector potentials that are used to induce mechanical forces on masses that are mechanically attached to the field sources.

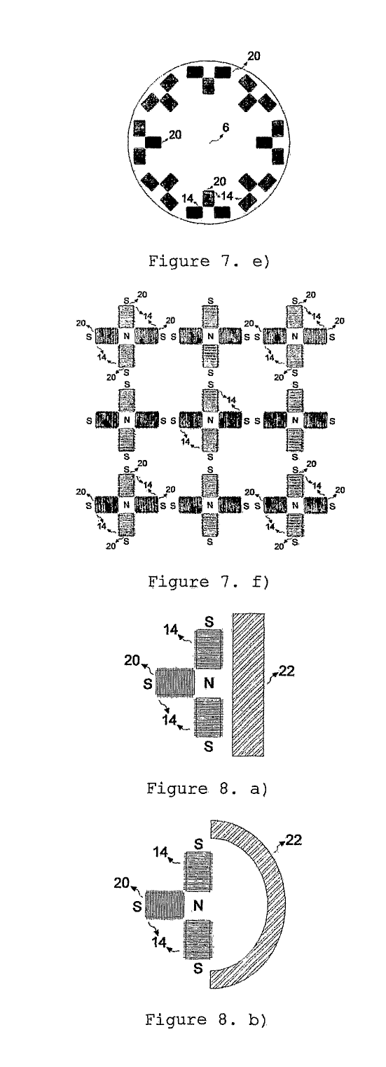

FIG. 7 depicts several symmetric arrangements with opposing magnetic vector potentials that are used to induce a directed mechanical force on masses that are mechanically attached to the field sources.

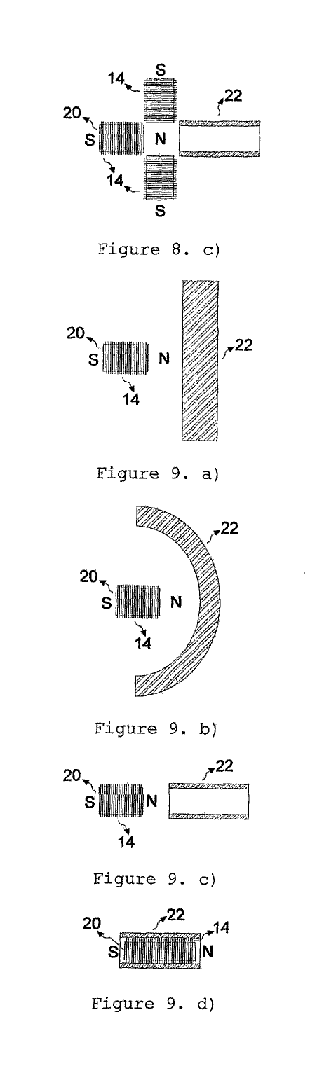

FIG. 8 depicts units of more than one magnet excited by coils, with opposing magnetic vector potentials that are used to induce a localized region that develop an antigravity force source, using opposing currents generated by the Lenz law.

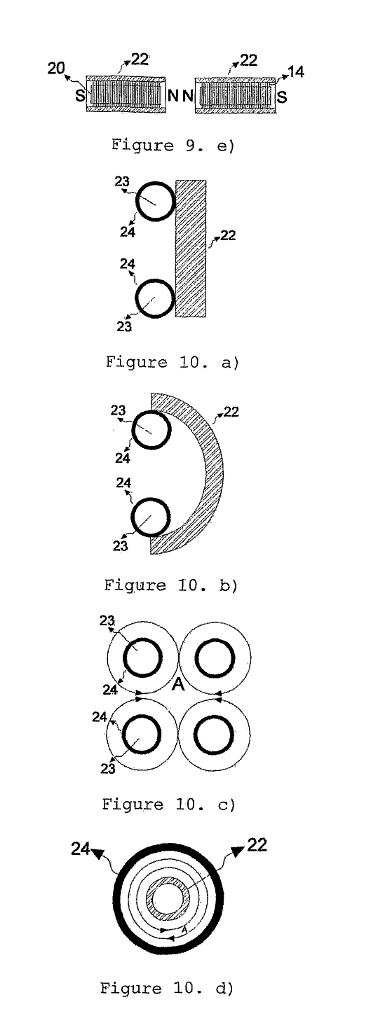

FIG. 9 depicts units with one magnet excited by coils, with opposing magnetic vector potentials that are used to induce a localized region that develop an antigravity force source, using opposing currents generated by the Lenz law.

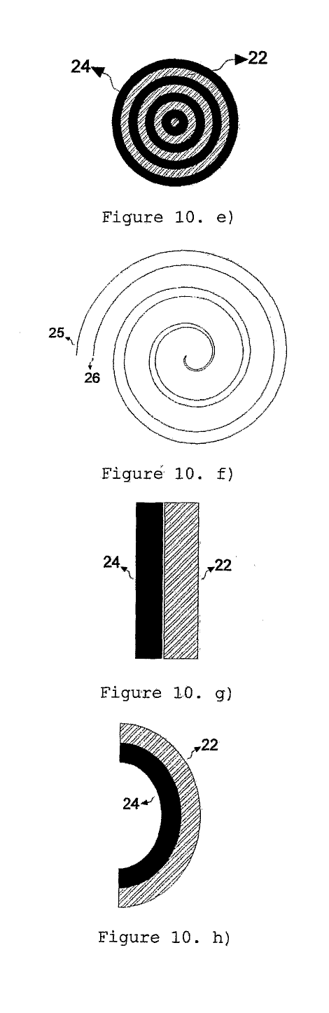

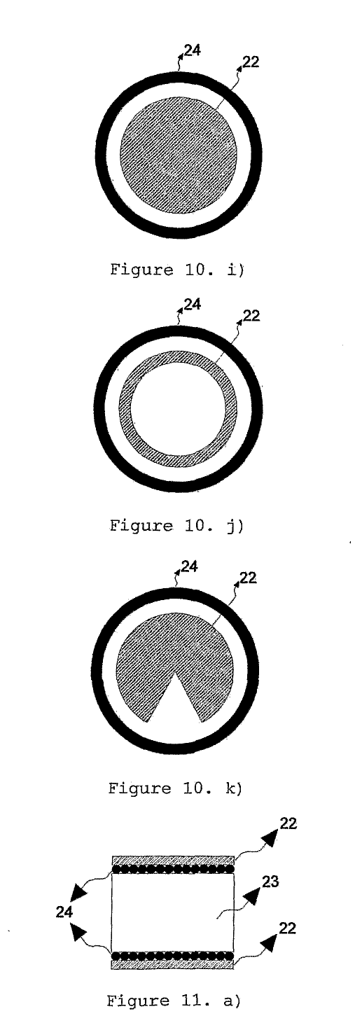

FIG. 10 depicts units with toroidal, flat and circular coils, with opposing magnetic vector potentials that are used to induce a localized region that develop an antigravity force source, using opposing currents generated by the Lenz law.

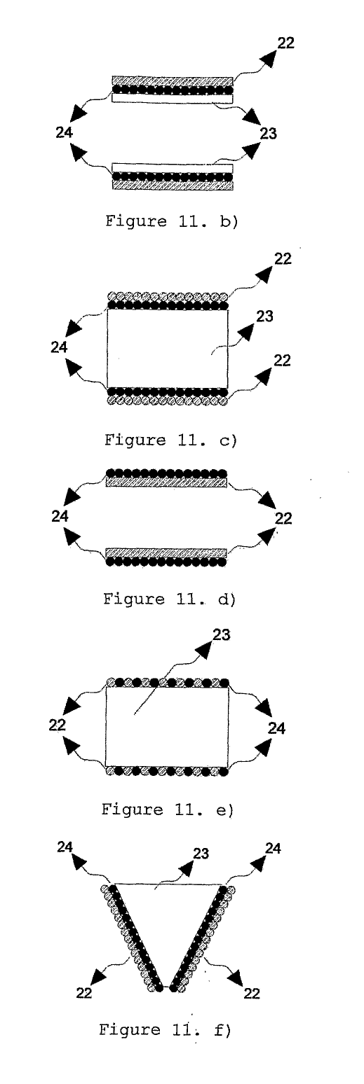

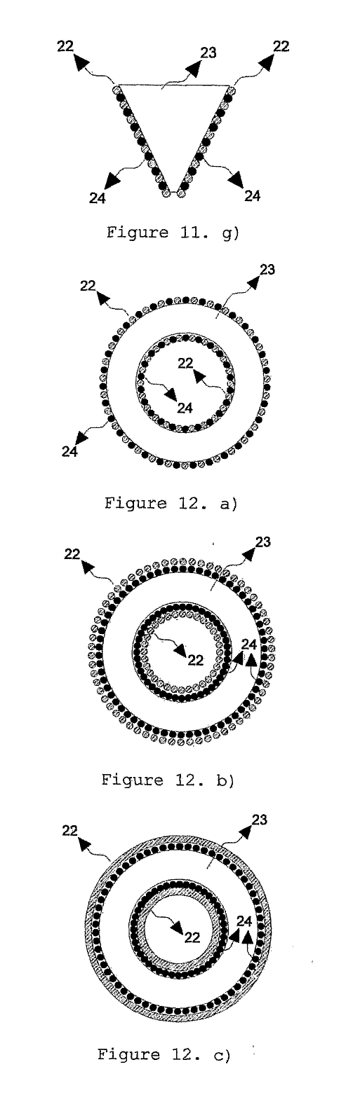

FIG. 11 depicts units with coils containing a ferromagnetic or magnetic core, with opposing magnetic vector potentials that are used to induce a localized region that develop an antigravity force source, using opposing currents generated by the Lenz law.

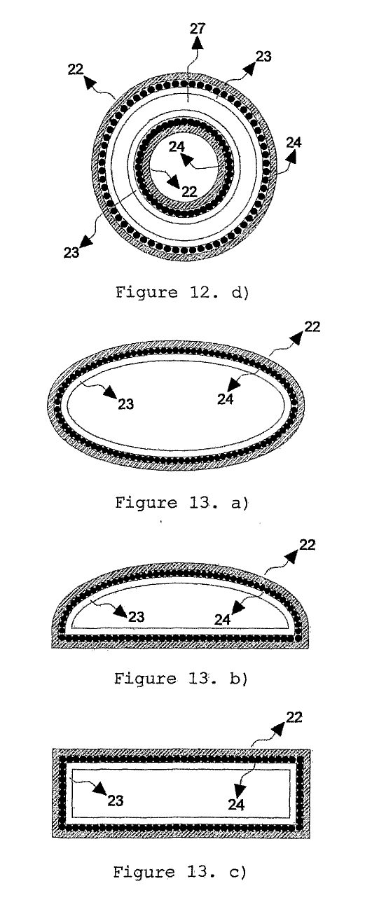

FIG. 12 depicts units with coils containing a ferromagnetic or magnetic core in a toroidal configuration, with opposing magnetic vector potentials that are used to induce a localized region that develop an antigravity force source, using opposing currents generated by the Lenz law.

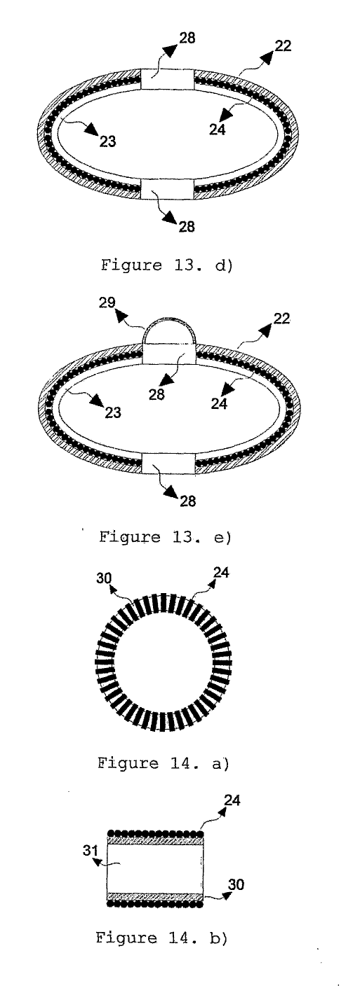

FIG. 13 depicts units with coils containing a ferromagnetic or magnetic core in several different configurations, with opposing magnetic vector potentials that are used to induce a localized region that develop an antigravity force source, using opposing currents generated by the Lenz law.

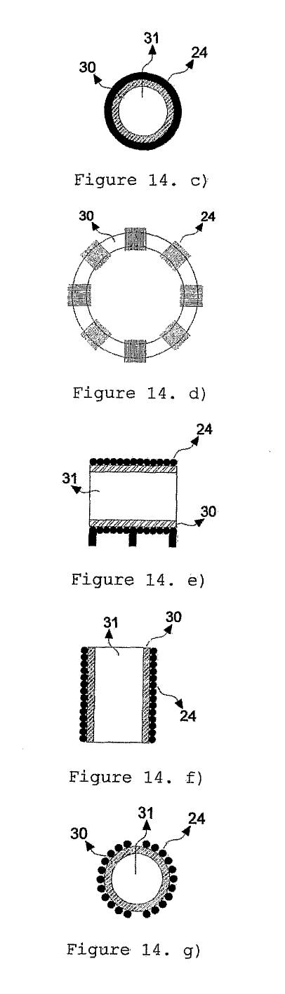

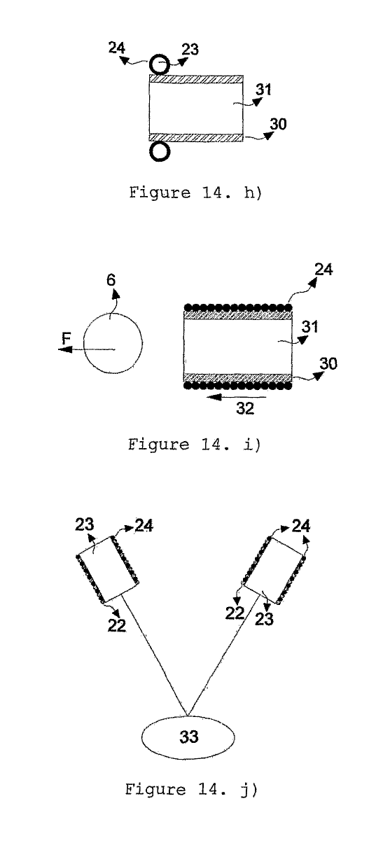

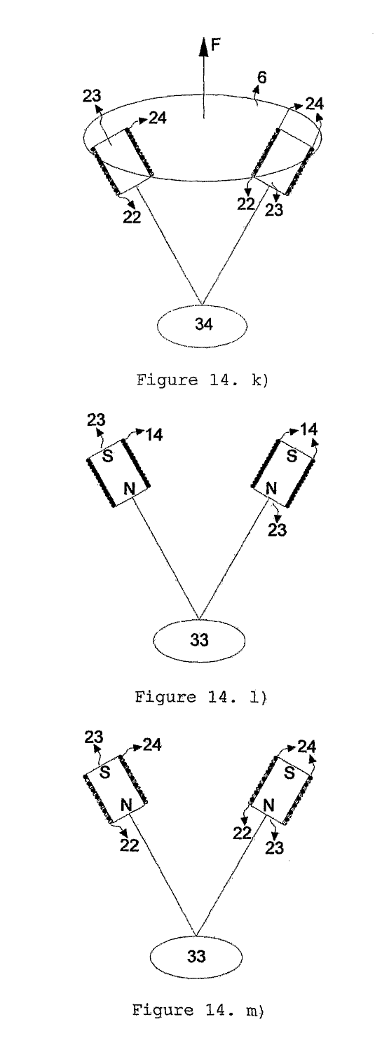

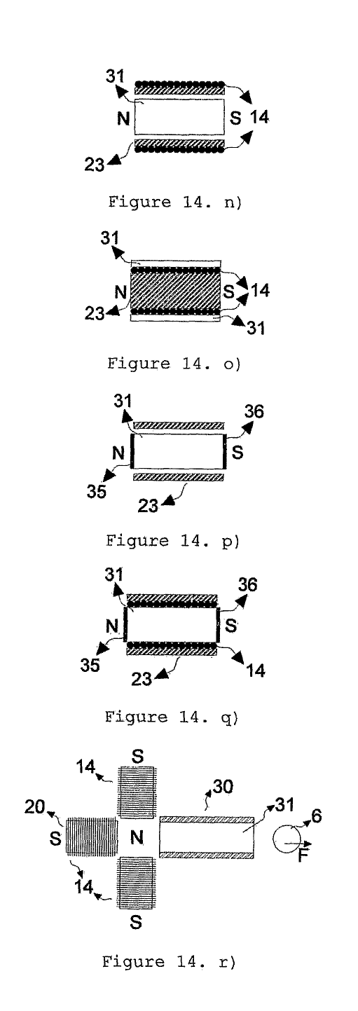

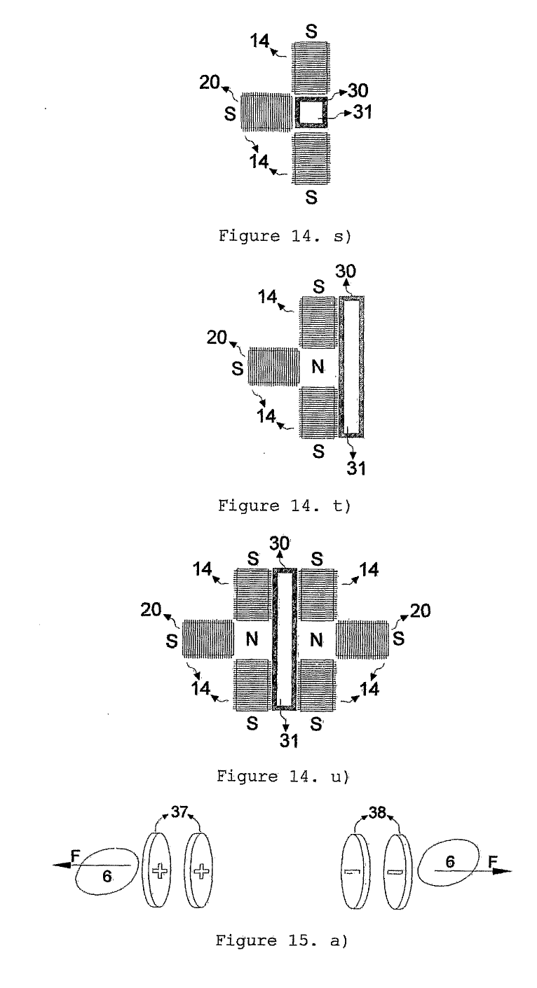

FIG. 14 depicts units with coils containing a conducting material in several different configurations, with opposing magnetic vector potentials that are used to induce a localized region that develop an antigravity force source, using opposing currents generated by the Lenz law.

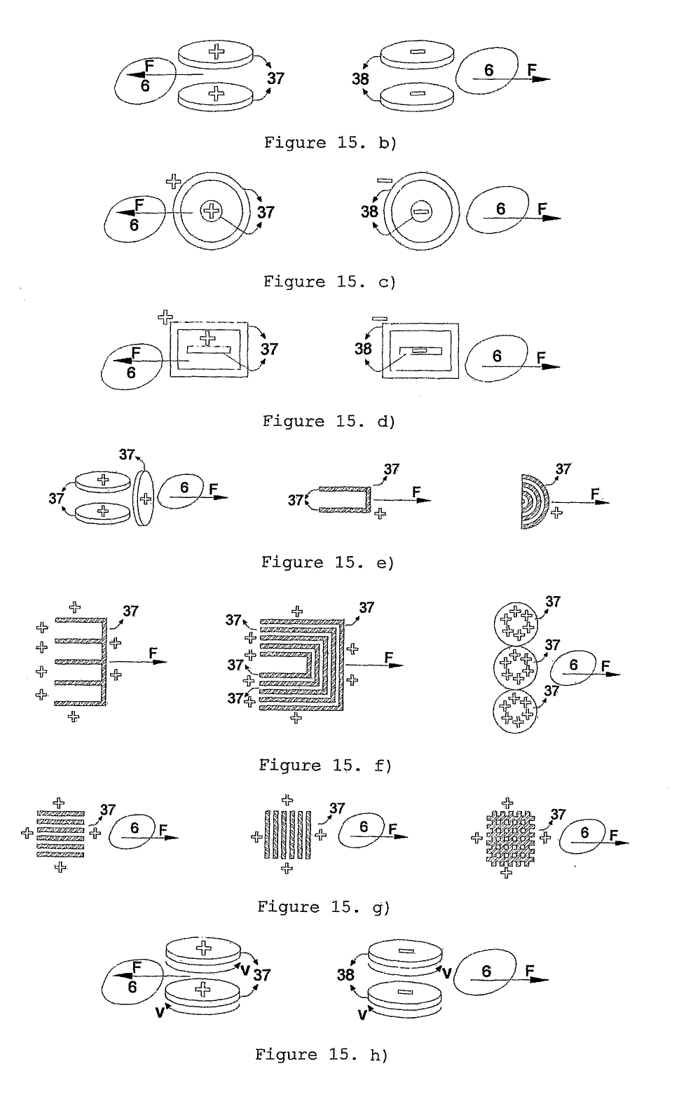

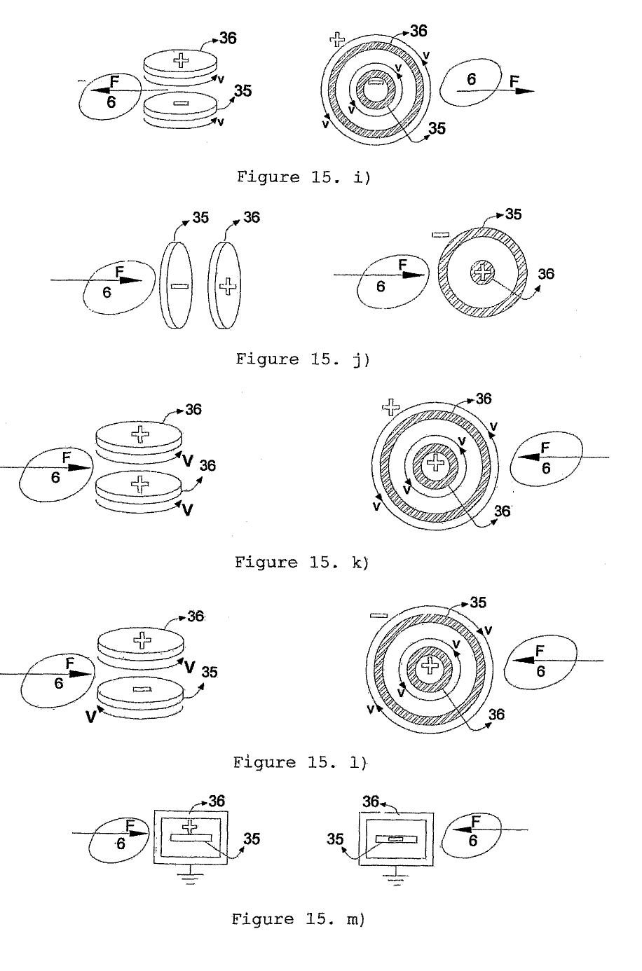

FIG. 15 depicts an embodiment where several arrangements of charged conducting plates are shown to induce mechanical forces on surrounding masses.

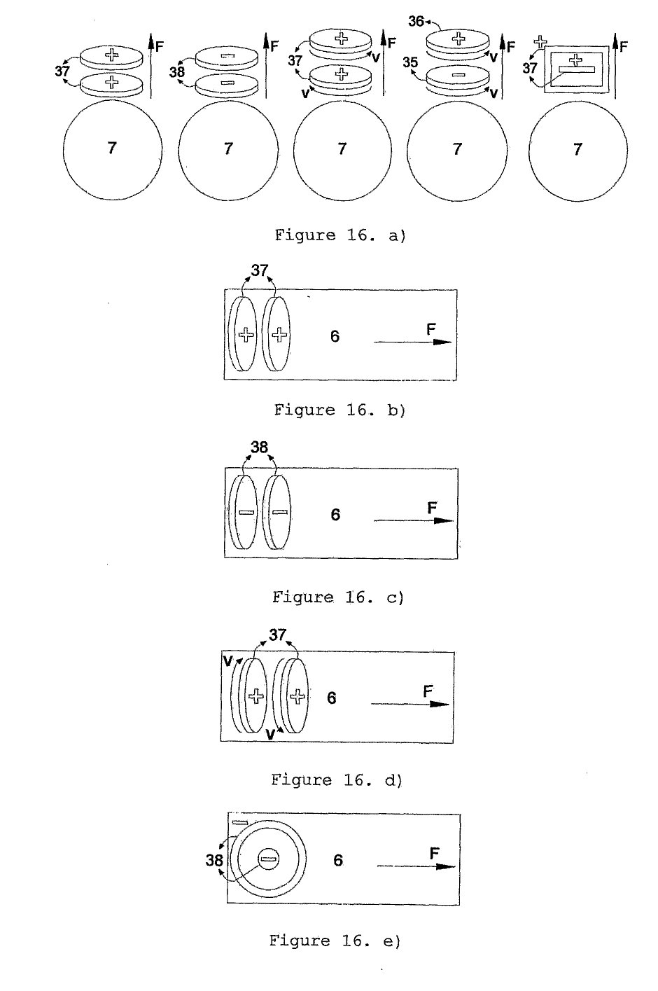

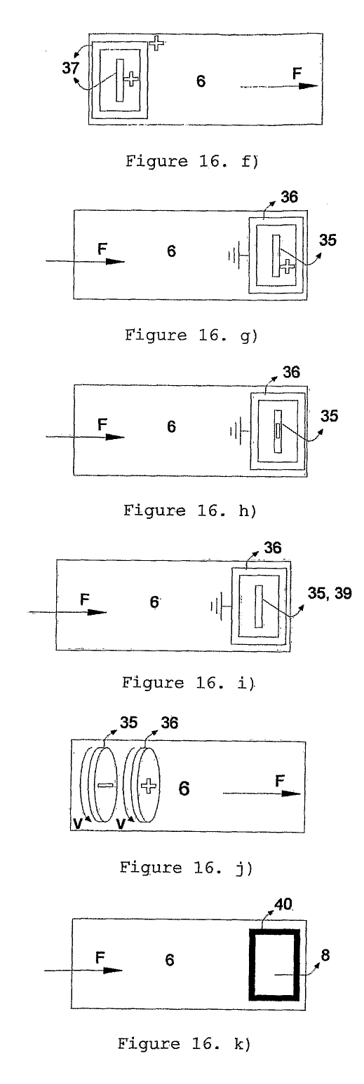

FIG. 16 depicts several units with charged conductors (and one unit with a plasma) that are used to induce mechanical forces on masses that are mechanically attached to the field sources.

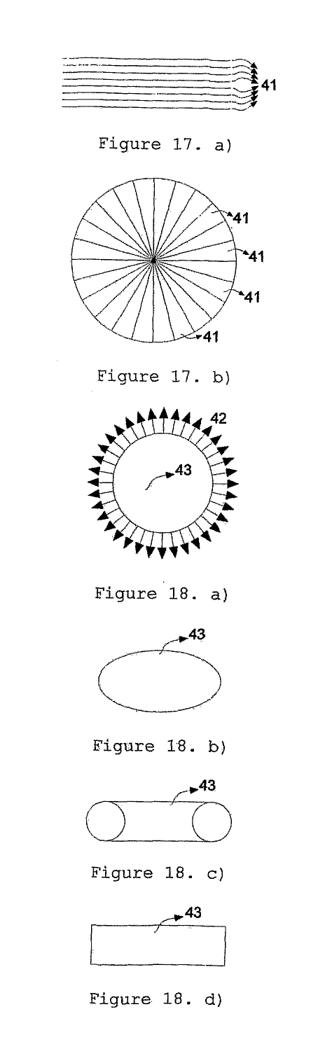

FIG. 17 depicts segmentation of charged conductors that can be used in great number side by side.

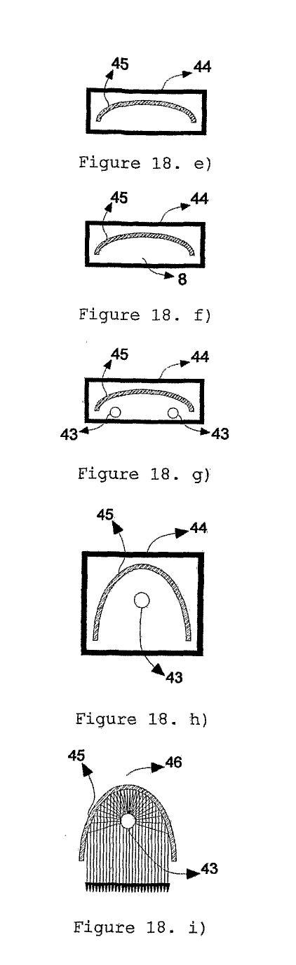

FIG. 18 depicts longitudinal electrodynamic wave sources.

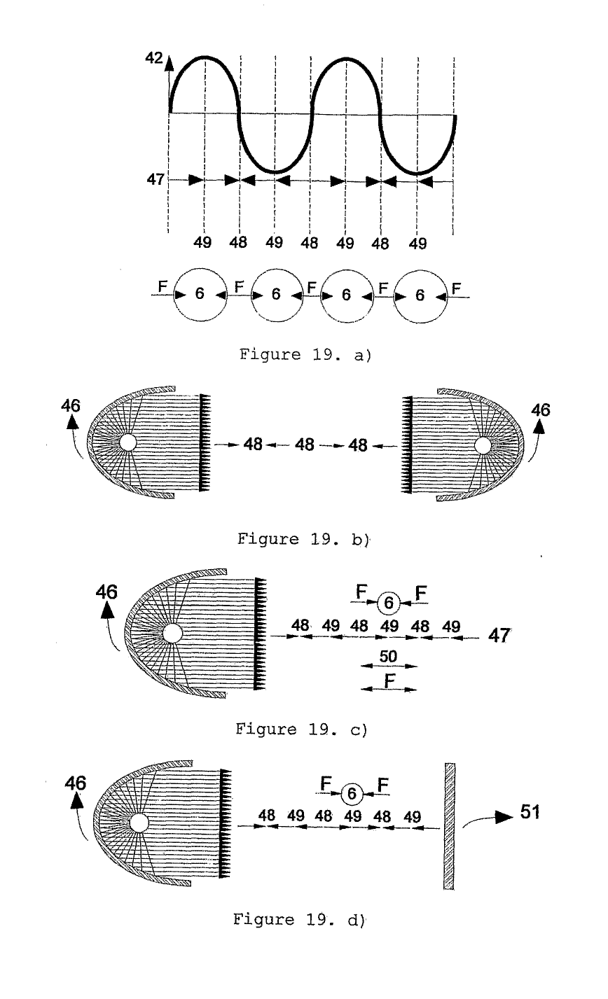

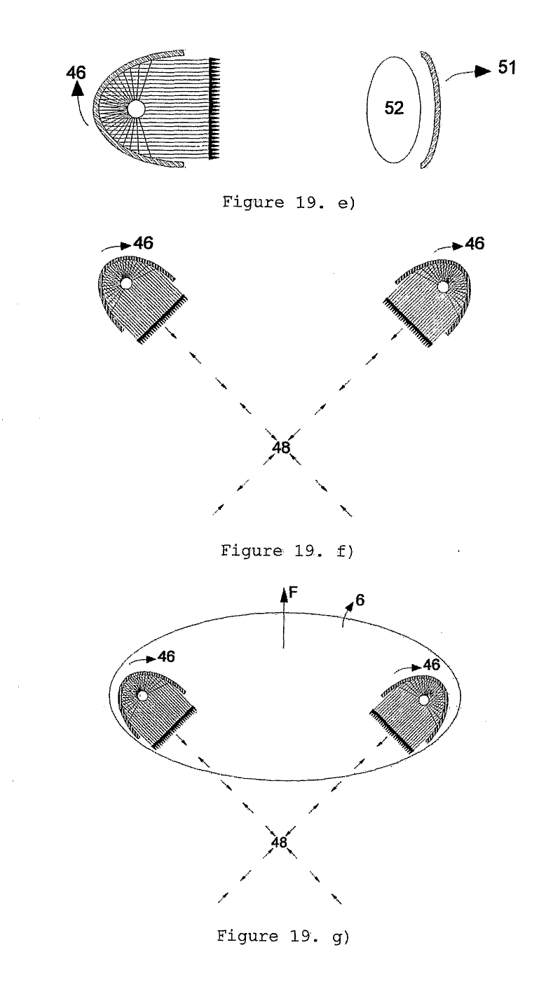

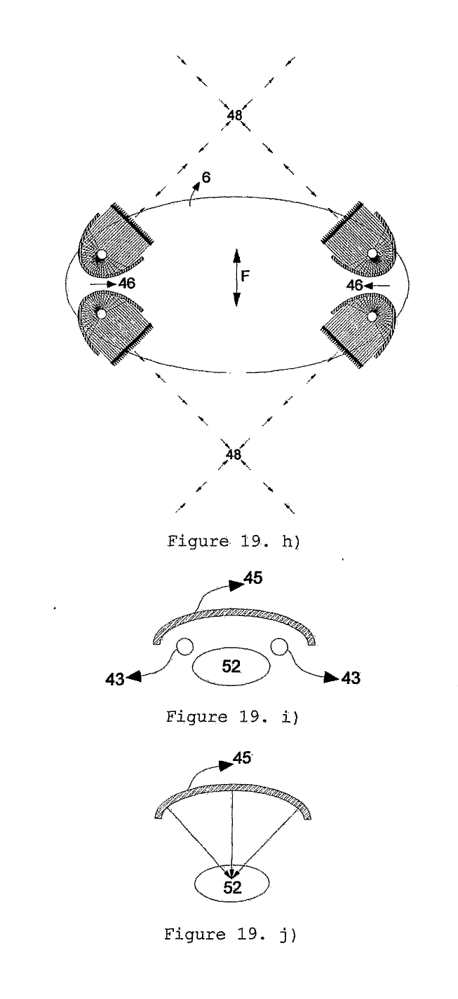

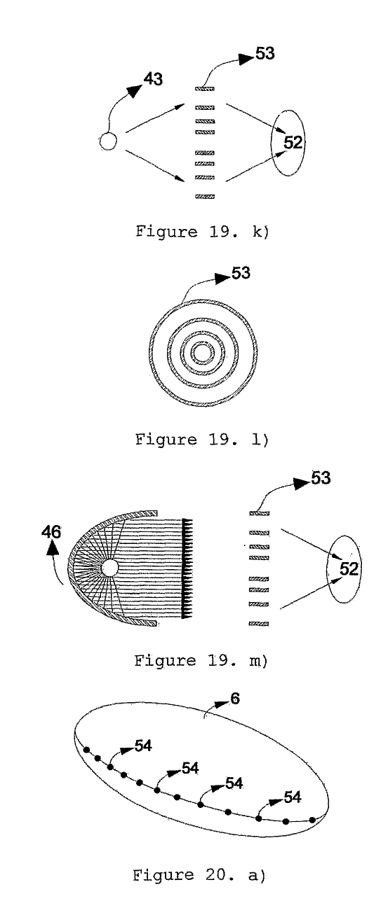

FIG. 19 depicts several embodiments which use longitudinal electrodynamic wave sources to produce interference at a distance with the purpose of inducing mechanical forces on nearby masses.

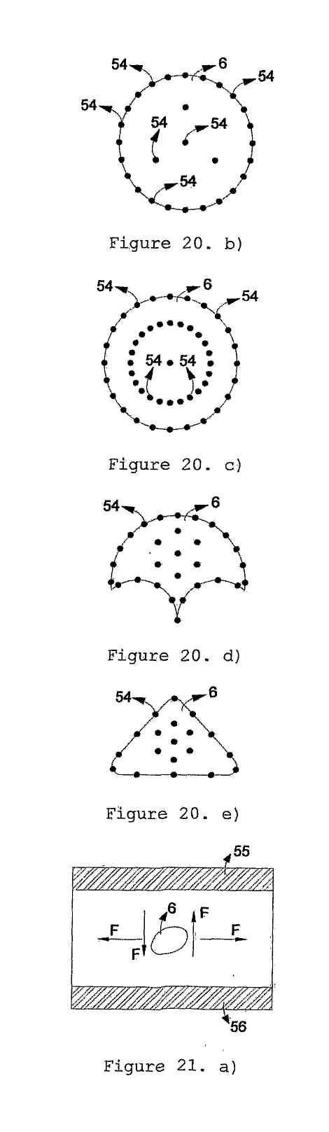

FIG. 20 depicts the use of several propulsion units disposed around different embodiments for the purpose of controlling and directing the generated propulsion force.

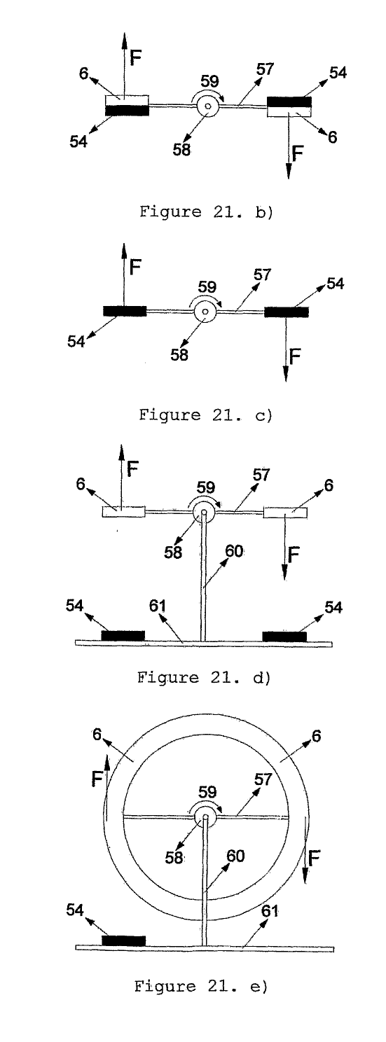

FIG. 21 depicts mass manipulation for recreational or energy production purposes.

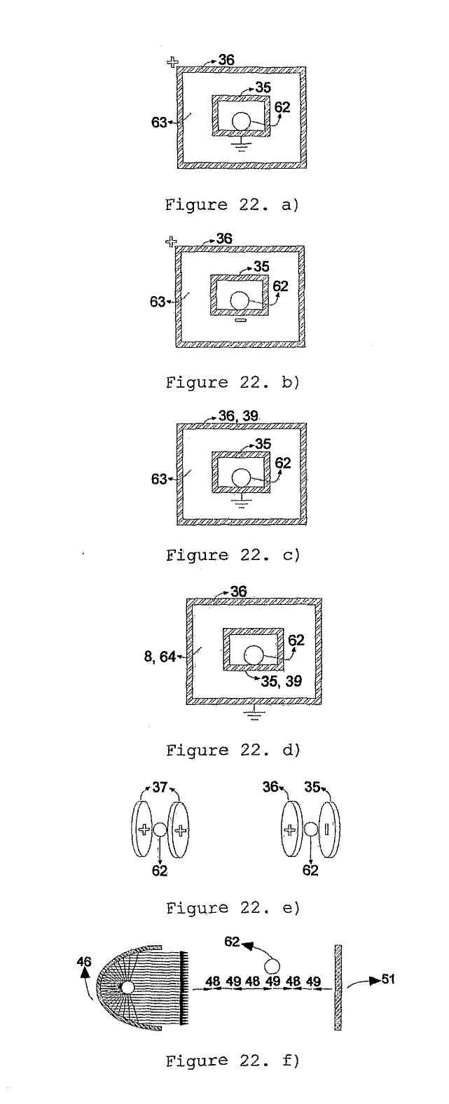

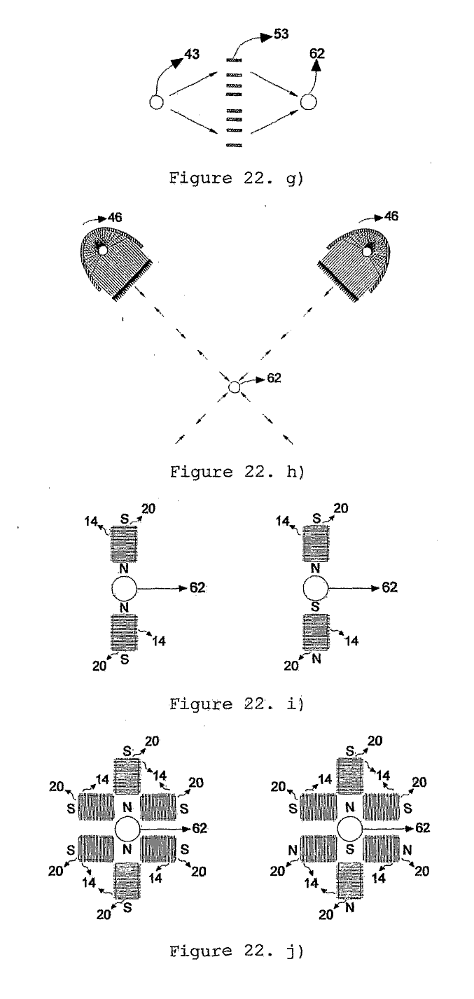

FIG. 22 depicts the use of opposing or attracting, electric or magnetic fields, to speed up or slow down the radioactive decay of radioactive elements, and energy production.

### DETAILED DESCRIPTION OF THE INVENTION

We will now proceed with the description of the preferred embodiments of this invention which are illustrated in the accompanying figures. Like numerals in these figures correspond to corresponding parts in the different embodiments.

We start by noting that Bushman's magnetic beam patent (1999) can be used for antigravity propulsion. Unfortunately, this fact is not mentioned in his patent where he only, mentions the production of a magnetic beam that can be rotated or directed, which is capable of generating higher magnetic fields for propulsion use in electric motors or levitating magnetic trains and is also capable to perform charge transfer. His concept is represented in FIG. 4.a). It consists of a geometric arrangement of opposing pairs of magnets 9-10 and 11-12 and unopposed magnet 13 (any number of magnets can be used). The letters N and S represent respectively the magnetic north and south pole. As we saw earlier, opposing fields increase the stress of the vacuum generating antigravity forces. This arrangement will generate a high vacuum stress between the opposing magnets, because the vector potential of the magnets is in opposition, which will induce gravitational repulsion from the area where the stress is highest.

FIG. 4.b) depicts a side view of the magnet arrangement trough vertical line BB shown in FIG. 4.a). If a coil 14 is wrapped around the magnet setup 15 (surrounding each magnet, the magnet setup or a few of the magnets), then the changing magnetic fields generated can be greatly increased, by exciting the coils with changing (oscillating, pulsing or any shape) electromagnetic signals. This will augment the magnetic vector potential strength of the opposing fields and consequently increase the vacuum stress that will induce strong antigravity forces (F) on nearby masses (FIG. 4.c)).

A setup like this could be used for propulsion with any number of units disposed around the periphery of the craft in order to generate directional forces. This setup is auto propelled because of its asymmetry of mass. Since there is more mass to one side (the unopposed magnet), it will be repelled from the higher vacuum stress zone. Bushman says that when the magnet arrangement is excited by a coil at ultraviolet frequencies it generates alternating magnetic fields with the equivalent strength of an electromagnetic pulse capable to destroy electronic components in a radius of several miles. The intensity of the generated magnetic field oscillations will increase with the frequency applied to the coils surrounding the magnets. This setup is ultra efficient for propulsion because of the extremely high opposing magnetic fields that can be created when the electromagnetic pulse is used. By using a higher excitation frequency we will generate higher opposing magnetic vector potential fields which will have a higher interaction with the vacuum by increasing its stress. In order to increase vacuum interaction and stress a number of different excitation processes can be used. Besides the use of symmetric or asymmetric waveforms (sinusoidal, triangular, squared, pulsed and others) at a single frequency (or at multiple simultaneous frequencies), any modulation can be applied to the carrier wave (frequency or amplitude modulation), were the arrangement of magnets 15 can be made to generate a rotating magnetic field or not. Even the frequency of the exciting wave can be changed continuously (chirped excitation) linearly or non-linearly, with or without any type of modulation. Other excitations may include white noise, pink noise, or any type of caotic electromagnetic excitation. The purpose of all these different excitation systems and frequencies is the possibility to excite and act on more vacuum zero point energy modes and frequencies according to the frequency spectrum generated by the oscillating magnetic poles that are excited by the coils. The antigravity force generated by this setup would be incredible with the advantage that the occupants would not feel any inertia force when being repelled by the stressed vacuum because they would be propelled directly by space. As is known, masses in free fall in a gravitational field do not feel inertia, because they are being moved by space itself and not against space.

When we excite these magnets with alternating frequency current (AC) they create a magnetic field change with time, but the pole of the magnet will remain the same. Therefore it creates a time varying pulsed magnetic field or pole with symmetric rising and falling times. If instead we use an asymmetric alternated or asymmetric pulsed excitation (asymmetric sawtooth wave, for example) to the coils, then the rising and falling times of the magnetic field of the magnets will be asymmetric. This will create a new effect, developing another force on space itself, since time changing magnetic fields generate time changing electric fields and these will induce a new (another) changing magnetic field in the space surrounding the setup. This is represented in FIG. 4.d). In this figure, 19 stands for the new induced magnetic field in space which always has the direction provided by the arrows 16, 17 and 18. 16 represents an induced magnetic field oppositely directed to the magnetic field of the opposed magnets 9, 10 and 13. 17 represents the alternating magnetic field induced if the excitation to the coils is alternating or symmetrically pulsed, and 18 is an induced magnetic field which is attracted to the opposing magnet pole 9, 10 and 13.

Therefore we have three different possible situations according to the type of excitation (AC or pulsed—symmetric or asymmetric) and related to the difference between the rise and fall times of the exciting source, which will determine the symmetric or asymmetric variation of the magnetic field of the magnets. In the case of situation 16, the magnet setup (9, 10 and 13) will be further repelled by this space induced opposed magnetic field, where a classical explanation (repulsion of like poles) is sufficient to understand the propulsive repulsion force. Situation 17 corresponds to the discuss ion related to FIG. 4.c), and situation 18 will induce a magnetic field in space that will attract the magnet assembly to it, in the opposite direction to case 16.

The magnets 20 can also be placed side by side in repulsion or attraction. FIG. 4.e) shows magnets 20 placed side by side (in a circular fashion) with the magnetic vector potentials in repulsion (magnets are in repulsion; in this case we have a south pole pointing upwards in all magnets). FIG. 4.f) shows the setup of FIG. 4.e) with an extra magnet 20 at the center also in repulsion with all the other magnets. And FIG. 4.g) shows the magnets of FIG. 4.f) surrounded by coils 14, which will augment the repulsion forces (between the magnets) when energized with a power source. When the magnetic vector potentials are in opposition any external mass will be repelled from that area, and when they are in attraction any mass would also be attracted. FIG. 4.h) shows another variation that can be used, were the magnets 20 (that can all be involved with coils 14 or not) are all in opposition but in a semicircular section. Like before, this arrangement will be auto-propelled to the right due to its mass asymmetry.

Any experimental setup that generates opposing and non-opposing fields respectively increases or decreases the vacuum stresses generating mechanical forces on masses in response to these vacuum density gradients. Therefore a multitude of geometrical arrangements can be used to generate antigravity forces, with a body of mass always being repelled from the high vacuum stress towards the low vacuum stress. This concept is illustrated in FIG. 5 for several configurations of repelling or attracting magnets 20, with coils 14 wrapped around them and excited by DC (direct current), AC (alternating current), or pulsed symmetric or asymmetric current. When we oppose all magnets, like in FIGS. 5.g) and 5.h), a symmetric setup is made with less external field leakage, and a stronger repelling field.

The only figures needing more explanation are FIGS. 5.e) and 5.f). In FIG. 5.e) we can find one coil 21 excited from the center to the periphery (or inversely from the periphery to the center); that's why this coil has three connecting wires: one in the center and another in each extremity. The reason for this setup is that exciting the coil through its center to the periphery (or inversely), we are able to generate opposing magnetic (vector potential) fields (or opposing induced electric fields, E=−∂A/∂t, generated by the changing currents) due to the fact that the current flows in opposite directions when going to the extremities. Therefore, we will induce one magnetic pole that is in opposition at the center and induce the other pole at both extremities. The changing currents will also induce opposing induced electric fields that repel each other. We can use a coil in two different configurations: in the first case (that we have just discussed) the wires from the center to the periphery of the coil go in opposite directions (anti-parallel), like when we just connect a wire to the center of a normal coil. In the second case the wires from the center to the periphery of the coil go instead in the same direction (parallel). In the parallel (second case) case we generate currents in the same direction and phase, and in the anti-parallel case we generate currents in opposite directions from the center to the periphery. The rotational direction of the coil wires between these two coils is opposite to the other, in the first case they are in opposite directions and in the second case, in the same direction. The generated forces will also be opposite. In the first case the opposed currents will generate a gravitational repulsion, and in the second case the attracting currents will generate a gravitational attraction. Our preferential embodiment is the coil used in the first case, although any coil may be used according to the desired purpose. If whished one can use a greater density or concentration of turns of coil wire on one of the sides of the coil. We may use only the center wire if we excite coil 21 with Tesla coils or the Avramenko's (2000) longitudinal system. The effect increases with increasing frequency and current. If we excite this coil (the preferential embodiment) in an asymmetric way by displacing the center wire to one side (FIG. 5.f)), the mass of the coil (and mass inside the coil) will feel a force to the left because the generated opposed poles and antigravity force will be stronger on the right. Again, one can use more turns of coil wire on one of the sides of the coil. This coil can be very small or the size of a whole spaceship (involving the outside of the spaceship or a smaller propulsion unit). Coil 21 can be an air core coil or it may have a ferromagnetic core or any type of magnet(s), which are surrounded by the coils, in order to increase efficiency. Please note that, although the coil(s) in FIGS. 5.e) and 5.f) are represented with a symmetric geometry, the diameter of the coil can be nonlinear. That is, it can have a bigger or lower diameter at the center and/or periphery. Another variation to the setup using this coil would be to wrap around coil 21 another coil or coil's (not represented) that would generate opposed currents to coil 21 in a passive (induction by Lenz law in response to currents in coil 21) way or in an active (by direct excitation of a power source) way.

FIG. 5.i) depicts several embodiments with opposing poles, near our planet Earth 7, that will lose weight and be propelled upwards when they are excited with DC, AC, pulsed symmetric or asymmetric (which also includes pulsed DC or AC) or rotating fields (the opposite fields can rotate in phase (or not) in the embodiments represented in FIGS. 5.g) and 5.h)). This happens because the high vacuum stress generated by these propulsion units repels the mass of our planet also. If the symmetric systems (embodiments in FIG. 4 and FIG. 5.f) are asymmetric) were excited in an isotropic gravitational environment, no force would be produced because of the external vacuum symmetry. An asymmetry in the surrounding stress gradient or mass distribution is needed for directional propulsion.

In FIG. 6 we have depicted the force generated by the units (propulsion units) described in FIGS. 4) and 5), which alter the vacuum stress locally. In this case each propulsion unit is mechanically fixed to a mass 6 so that when they are excited with a power source a repulsion force will be generated in the vacuum, which will act on the surrounding mass 6 that will also transport the propulsion unit with it. This happens because there is more mass being acted upon in a given direction (or an asymmetric distribution of mass), outside the opposing magnets/coils, which will determine the direction of propulsion. Since these propulsion units repel all mass, generally they have to be used at the extremities of the volume to be propelled so that the mass is concentrated in the direction that the force is to be produced. FIG. 6 represents several possibilities of directional propulsion which are not limiting in nature. If some of these units have attracting fields instead of opposing, then an opposite directed force would result (mass would be attracted to these areas).

In order to achieve directional control, several propulsion units have to be distributed along the periphery, as illustrated in FIG. 7. These are just a few examples and are not limiting in nature. Each represented section can be energized independently in order to vector the propulsion force. If desired, a grid of repelling magnets wrapped in coils can be used as a propulsion unit with greater surface area (FIG. 7.f)). The coils 14 illustrated are wrapped around magnets or ferromagnetic cores 20. The coils that excite magnets can also be made of fiber optic, instead of conducting metal. One can always choose to use repelling or attracting forces to vector propulsion. The use of repulsion forces has certain advantages like repelling also the surrounding atmosphere in operation while on a planet. When traveling, repulsion fields would be generated in the front in order to reduce friction and interaction with the atmosphere; and stronger repulsive fields would have to be generated in the backward section in order to achieve forward propulsion. Other simpler alternative would be to use only the repulsion fields at the back which would also repel the atmosphere in the forward part of the vessel.

FIGS. 8 and 9 illustrate magnets or ferromagnetic cores surrounded by coils 14 (these coils can have or not element 20 inside their core). The use of a ferromagnetic material will increase the magnetic vector potential generated by the currents in the electromagnetic coils thereby augmenting the effect, but the excitation of magnets by coils (metallic conductors, fiber optic conductors, or plasma conductors) is more efficient due to the electromagnetic pulse that is generated when the excitation of the magnet by the coil is at high frequencies like, for example, ultraviolet frequencies. The coils/magnets (arbitrary number can be used) are excited near a diamagnetic or paramagnetic (or any) metal conductor (22) (that may also be a non-conductor (dielectric), or semi-conductor or be any other material, that may rotate or not, or that may be superconducting or not, or that may be charged (to any polarity or voltage) with a static (not changing) or dynamic (changing) charge, or that may be not charged) in such a way that opposing magnetic vector potentials from currents, and/or opposing induced electric fields E=−∂A/∂t (or magnetic fields) are induced in element 22 according to the Maxwell equations (including specially the Faraday law, Lenz law, and the Ampere-Maxwell law), causing a repulsion force between elements 20 (and 14) and element 22. This repulsive interaction will increase the vacuum stress in that area, generating an antigravity force that will act on any nearby mass.

FIG. 8.a) depicts a flat conductor 22 that will respond to the excitation of magnets 20 (that are surrounded by coils 14) with opposing currents and changing electric fields. FIG. 8.b) shows element 22 as a curved metallic conductor instead of a flat one like in FIG. 8.a) (this round shape may eventually be conical also, or any other). In FIG. 8.c) the element 22 is a metallic cylindrical tube (which may also be a cone) placed in front of the magnet/coil assembly and is used for the same purpose. In all these embodiments, element 22 may be superconductor or not, or may be charged or not, and may rotate or not.

FIGS. 9.a) and 9.b) are equivalent to FIGS. 8.a) and 8.b), but with only one magnet/coil being excited near element 22. FIG. 9.c) depicts a magnet/coil being excited near a metallic cylindrical (or conical) tube 22 for the same purpose. FIG. 9.d) shows the magnet(s) 20, with coil(s) 14, inside the metallic tube 2′2 for improved performance, and FIG. 9.e) shows two such units in close proximity and in repulsion one to the other. Like before, in all these embodiments, element 22 may be superconductor or not, or may be charged or not, and may rotate or not.

Since the magnetic vector potential of coils is augmented by materials of greater magnetic permeability, it is advantageous to use such materials and impose opposed (or non-opposed) vector potentials. The coil and the respective cores can be cylindrical, toroidal, rectangular, conical or any other shape (FIGS. 10 to 13). An asymmetric shape would also induce a force on the system. But the primary interest here is to generate vacuum stress gradients to apply on surrounding masses for propulsion and control.

We can use straight cylindrical coils or toroidal coils 24 near a flat (FIG. 10.a)) or curved (FIG. 10.b)) element (with the same properties referred to before). Several cylindrical or toroidal coil(s) can be used, with or without element(s) 22 in proximity, in order to generate opposing vector potential fields (and opposing induced electric fields E=−∂A/∂t or magnetic fields, according to the Maxwell equations, including specially the Faraday law, Lenz law, and the Ampere-Maxwell law) to create antigravity forces on any surrounding mass. In this case we can have symmetric (FIG. 10.c)) or asymmetric toroidal coils (2 or more), with different geometric dimensions. These coils can be energized by dc, ac or pulsed currents. The coils can have an air core or preferentially a ferromagnetic (or other) core 23, that may also be any type of magnet(s) (with any shape and cross section). The ferromagnetic/magnetic core will increase the magnetic vector potential strength, therefore increasing the efficiency of the vacuum stress generation. We could also have an element or coil 22 inside another coil 24 (FIG. 10.d)). If coil 24 is excited with a changing current, then it will induce opposed currents in coil 22. We can have several layers of coil(s) 22 and 24 interposed (FIG. 10.e)) between themselves. The passive coil 22′ can also be excited with opposed currents to coil 24 if desired.

In a similar way, planes of parallel cylindrical coils can be used to create repulsive or attractive gravitational forces in surrounding masses. If the currents (and generated changing electric and magnetic fields) in the coils are in opposite directions nearby, then a repelling force will be generated on nearby masses. These planes of coils are disposed in the periphery of the mass in order to induce directional movements through selective activation of the coils. Any embodiment with coils or magnets that is excited by a changing current will also generate a repulsion force to other coils or passive conductors 22 when the induced electric field (E=−∂A/∂t), due to the time change of both currents, is in opposition. We which to emphasize that, whenever we mention the induction (or interaction) between opposed currents, the opposing force is not only provided by the currents that are in opposition but also by the interaction of the induced electric fields generated by those changing currents (changing vector potential). That is, the opposing force also contains an electric repulsion (or attraction) interaction component, and not only a magnetic factor. This is an important remark since we can have an important repulsion force between changing currents without having to generate necessarily big currents that could heat too much the material of the used conductor(s). This understanding is employed in all embodiments in this patent using interactions between changing currents.

FIG. 10.f) depicts two flat coils wrapped side by side (with or without a ferromagnetic or magnetic material 23 interposed between coils 25 and 26). Coil 25 is active and excited by AC or pulsed currents. Coil 26 is passive (closes on itself) and is of a diamagnetic/paramagnetic material which will passively generate opposed currents to coil 25 by induction through the Lenz law. Or alternatively, coil 26 can also be active and excited by a power source in order to generate opposed currents to the currents of coil 25.

In like manner, different embodiments of this concept are depicted in FIGS. 10.g) and 10.h). FIG. 10.g) represents a flat coil 24 (or a magnet(s) or ferromagnetic core surrounded by a coil 24) near a flat diamagnetic, or paramagnetic (or any other) conducting surface 22. If element 24 is adjusted to a curved conducting surface 22, we have the situation depicted in FIG. 10.h). As before, element 24 is active and 22 is passive (or eventually also active).

Alternatively we can have a circular coil 24 (with or without a magnetic or ferromagnetic core 23), which surrounds a metallic conducting plate or coil 22, like in FIG. 10.i). Element 22 can be a circular ring (or a circular coil, active or passive), like in FIG. 10.j). The central element 22 can also be asymmetric (FIG. 10.k)), but this time will also develop a directional force due to the asymmetry of element 22. In this case, the opposed induced currents on the asymmetric element 22 will also be in opposition between themselves. Please note that the referred coils 24 (or elements or arrangements of elements 23 surrounded by coils 24) in FIGS. 10.i) to 10.k) can also be above or below element 22. In these last embodiments (FIGS. 10.g) to 10.k)), element 22 may be superconductor or not, or may be charged or not, and may rotate or not. Or one can use a ferromagnetic (or magnetic, or other) material 23 together with elements 22 and/or 24, or eventually use several parallel planes of elements 22, and/or 23, and/or 24 interposed in succession.

FIGS. 11 to 13 represent different variations of the same, physical principle. We have (or not) a core of ferromagnetic material (or simply a magnet(s) of any type) 23 with a coil 24 wrapped around it (from the inside or outside). Element 23 will amplify the vector potential generated by the coil when it is excited by AC, or pulsed currents. When this vector potential changes around the coil(s) (one or more) 24 surrounding or involving (from the inside or outside; or instead intermingle in the same plane) a tubular (conical, toroidal, oval, spherical, cylindrical or any other shape; hollow or not) element 22 (with the same properties referred to before, and connected or not to a power supply), the element(s) 22 (when not connected to a power source) will generate opposed induced currents, and opposing (changing) electric fields (and also magnetic fields) in response to any externally applied changing electromagnetic field (or fields) generated by coil or coils 24. Element(s) 22 (when connected to a power source) will generate opposed currents and opposing (changing) electric fields (and also magnetic fields), in relation to the changing electromagnetic field (or fields) generated by coil or coils (24). These opposing fields will generate antigravity forces that can be used to vector propulsion as discussed before. In all these embodiments, either (or both) coil or coils 22 and 24 can be formed by a tubular coil material (of any shape) that can allow the presence of a (conducting) plasma inside.

FIG. 11.a) shows the setup described before with a solid ferromagnetic core (or a magnet(s) of any type) 23 and a metallic tube 22 surrounding (from, the inside or outside) coil 24. The element 23 can be hollow as shown in FIG. 11.b). Instead of a metallic tube 22 around coil 24 we can have an active or passive (excited or not by a power source, respectively) coil 22, as in FIG. 11.c). Or we can have a coil 24 surrounding (from the inside or outside) element 22 (FIG. 11.d)) which will generate opposed currents according to Lenz law.

Instead of surrounding coil(s) 24, coil(s) or element(s) 22 (active or passive) can involve (side, by side or intermingle) coil 24 (in the same plane) as shown in FIG. 11.e). FIGS. 11.f) and 11.g) show, respectively, how the elements 22, and/or 23, and/or 24, in FIGS. 11.c) and 11.e) can be conical, or have any other shape (even be hollow). In these embodiments, element 22 and/or 24 may be superconductor or not, or may be charged or not, and may rotate or not. Or one can use (or not) an element 23 together (or not) with element(s) 22 and/or 24, or eventually use several parallel (or at any other angle) planes of element(s) 22, and/or 23, and/or 24 interposed in succession.

FIG. 12 shows a toroidal shape for the same concept. In FIG. 12.a) we have passive (or active) coil 22 involving (laterally in the same plane) active coil 24, and a solid ferromagnetic (or magnetic) core 23 which can also be hollow. Coil 22 can also surround (from the inside or outside) coil 24 as in FIG. 12.b). Passive (or active) element 22 can be a solid metal with a toroidal shape like in FIG. 12.c), or can have a hollow (27) toroidal ferromagnetic (or magnetic) core 23 (FIG. 12.d)).

FIG. 13 repeats the same concept with other shapes. In FIG. 13.a) we have an oval shape, in FIG. 13.b) a saucer shape, and in FIG. 13.c) a cylinder or rectangle shape. Openings 28 can be introduced where desired (FIG. 13.d)), and we can introduce windows or cupolas 29 for viewing purposes (FIG. 13.e)). These windows can be made of any transparent material, including transparent metals, glass, plastic, or other. The coil 24 represented in these last figures can be more than one (any number of coils parallel or perpendicular to one another) and can be divided into different or independent sections. This coil or sets of different coils can be excited by AC, pulsed or rotating magnetic fields (monophasic or poliphasic excitation). As shown, the element 22 can be the external conducting surface of the craft or any internal element.

Please note that in all the preceding setups where we have passive coils or metals 22 that transport current only because of induction due to an active coil 24, can also be used has active coils with currents in opposition (or not) relative to the primary active coil 24. In this case, we can use a DC, AC, pulsed or rotating field excitation of both coils.

Please note that, although in FIGS. 11 to 13 there is used a ferromagnetic (or magnetic) core 23 near the exciting coil 24 (or 22), all these embodiments can equally function without any element 23. In these embodiments, element 22 may be superconductor or not, or may be charged or not, and may rotate or not. Element 23 can be used together with elements 22 and/or 24, or eventually we can use several parallel planes of elements 22, and/or 23, and/or 24 interposed in succession. Eventually, element 24 can have all the properties ascribed to element 22.

Therefore, we can use excited magnets (surrounded by coils) and/or coils (14, and/or 22, and/or 23, and/or 24) or arrangements of them interacting with the metallic conducting skin of the craft (or interior metallic elements). The external element 22 and/or 23, and/or 24 would generate opposing currents in relation to the coils or magnets (20, and/or 14, and/or 22, and/or 23, and/or 24). This repulsion force produced would increase the vacuum stress locally and the masse of the craft would be repelled by the high vacuum stresses generated by these units inducing propulsion of the whole system. When using opposed currents trough the Lenz law we must remember that there is a frequency limit for which the metal will respond. It is known that metals become transparent to electromagnetic radiation above the ultraviolet range. If the excitation is at or above these frequencies then the metal would not generate opposed currents through the Lenz law. Nevertheless, other systems described would continue to function at these frequencies, namely any asymmetric magnet arrangements excited by fiber optic at these higher frequencies (which function independently of having or not a metallic conductor in front of the unpaired magnet). Propulsion efficiency, increases with applied frequency and also with a larger spectrum or frequency bandwidth of the generated signals.

A different configuration is depicted in FIG. 14.a) which depicts a toroidal chamber 30 involved by a coil 24 (with or without a ferromagnetic or magnetic core 23, inside or outside coil 24). The longitudinal section of this chamber is shown in FIG. 14.b), and the cross section in FIG. 14.c). There we can see a coil 24 surrounding a chamber 30 which contains a conducting diamagnetic (or paramagnetic, or semi-conducting, or superconducting, or non-conducting, or any other conducting or ionizable) material 31, which can be in liquid, gas, vapor or plasma (ionized) form (in any combination, like ionized mercury vapor, for example), that may be charged (to any polarity or voltage) with a static (not changing) or dynamic (changing) charge, or that may be not charged.

When the coil 24 is excited by AC, pulsed or rotating field, then element 31 will strongly respond with opposing currents due to the Lenz law. This will generate an antigravity force. As a way of example, this toroidal chamber 30 can occupy the whole outside perimeter of the craft(s) detailed in FIG. 13. If the coil 24 in figure 14.a) is operated around the whole circumference, then a uniform antigravity force will be generated. If the coil 24 is separated into different sections around the perimeter (the toroidal chamber 30 can also be separated into different and independent sections) like in FIG. 14.d) then directional propulsion can be achieved by isolated excitation. Alternatively, the coils 24 in FIG. 14.d) can be independent units like shown in FIG. 14.b). FIG. 14.e) shows coil 24 excited from the center to the periphery (or inversely) that will also interact with the generated opposing currents by element 31, to develop an antigravity force. FIG. 14.f) shows a propulsion unit in vertical position. It can also be used as a vertical mast in the craft(s) of FIG. 13 (as an example) in order to provide a sustaining antigravity force. A variation of this geometry is shown in FIG. 14.g) with a cylindrical shape, where we have a coil 24 surrounding the circular chamber 30 that contains element 31. This setup will also function as a propulsion unit. As a way of example, the use of three of these units at the bottom of a craft can be used to vector propulsion. The element 31 inside the chamber 30 can also be excited with a toroidal coil 24 (FIG. 14.h)), which may have a ferromagnetic or magnetic core 23.

If the coil 24 of FIG. 14.b), is excited with a propagating pulsed current 32 to the left (FIG. 14.i)), then element 31 inside the chamber 30 responds with opposing currents. Since these opposing currents are propagating to the left, then a propagating antigravity wave will be emitted which will transmit a force to any mass in its path. This can be used for propulsion purposes and also to transmit force to any mass at a distance.

If mercury is used as the diamagnetic material, then it is of advantage to work at the temperature and pressure where the mercury behaves has a superconductor (Kohno and Yao, 1999). Operation at these parameters would greatly increase the force effects. Note that any other conducting material 31 (diamagnetic, superconductor or other) can be used. Although not mentioned before, all embodiments with passive (or active) elements 22 or 31 (solid, liquid, vapor or plasma) will generate opposed currents more efficiently if they are superconducting.

It is to be noticed that all the setups represented in FIG. 11 can also be used to generate gravity or antigravity beams depending on excitation of the coils 24 (and/or 22). If the coil 24 is excited with a directional pulsed, current like in FIG. 14.i) then an antigravity beam would be emitted. Electromagnetic waves of propagating opposing fields or attracting fields will function as antigravity or gravity beams, respectively (depending also on the sense and direction of the phase of the propagating wave). A setup (FIG. 11) with one or more conducting wires (coils, elements) could be used to generate a gravity or antigravity beam depending if it propagates non-opposing or opposing fields along its length. If element 22 is passive then it can only generate opposing fields. It functions as an antenna emitting vacuum stresses that can be attractive or repulsive. For example, if we have two conducting wires (24 and 22 are both active and excited) and both carry a current were the current of one wire (or of both wires) is phase shifted in relation to the other, we can create propagating opposed or non-opposed fields, that would be emitted from the coils like radio waves are but with the property to exert forces in its propagating path according to the vacuum stress being propagated, and of the sense and direction of the phase of the propagated wave. A traveling standing wave is generated by causing a slight phase difference between two phase cancelled carriers. By varying the phase (by changing the phase of the exciting frequency(ies) or of the modulation of this frequency(ies)), the standing wave field can be caused to walk or move. In this manner it is possible to create fixed or moving points in space (using one or more units that interfere in space) that are attractive or repelling (FIG. 14.j), were 33 represents an attraction or repulsion point, and element 23 can also be element 31). Besides the use as an attractive or repelling beam, it can be used to create attractive or repelling points in space to cause a propelling force on a craft or mass 6 (FIG. 14.k)), were 34 represents a repulsion point, and the element 23 can also be element 31). The use of this system while emitting a traveling wave of repulsion can be used to impart a constant force on any nearby mass (a craft or any other mass 6; being a possible application the extinguishing of fires). Another embodiment of this concept (FIG. 14.l), where 33 represents an attraction or repulsion point), would use two or more magnets 23 (or 20) surrounded by coil(s) 14 (or coils 22 and/or 24 (figure 14.m), where 33 represents an attraction or repulsion point) that would interfere at a distance (as described before) in order to create an attraction or repulsion point. Please note that, although not shown, the mentioned coils can be in any position around the magnet(s): at the front, side, back or around the magnet(s) or the complete setup of magnets.

In a different way (FIG. 14.n)), one could use a hollow magnet 23 (or 20) surrounded by a coil or coils 14, which contain a chamber with a conducting material 31 (that is diamagnetic, or any conductive or ionizable element in liquid, gas, vapor or plasma form). Alternatively (FIG. 14.o)) the magnet is not hollow, and the chamber with the material 31 is on the outside of the magnet 23 (or 20) and of the coil 14 (22 and/or 24). In these last two embodiments, the excitation of coil(s) 14 (22 and/or 24) will induce opposed currents in the conducting material 31 (amplified by the magnetic field of the magnet). The generated field opposition will create an increased vacuum stress which will induce a repulsion force on nearby masses which can be used for propulsion purposes if the excitation is directional (from right to left for example), and waves with fields in opposition are emitted in space, then masses on the propagation path will be subject to a directional force. In an alternative way, one could also use two electrodes 35 and 36 (of any conducting material, that are superconductive or not) on the extremities of the chamber containing the material 31, that is inside (or outside) a magnet 23 (or 20) (FIG. 14.p)), and eventually use a coil or coils 14 (and/or 22 and/or 24) that can be active or passive, surrounding that chamber (FIG. 14.q)). In these last two cases, the material 31 is excited by an electrical discharge using electrodes 35 and 36. Since the discharge occurs inside a magnetic field, the particles will have a spiral movement towards the opposite electrode in a way to generate a magnetic field opposite to the applied field of the magnet. If there are one or more passive coils 14 that are surrounding the chamber with the material 31, then these coils will generate currents that are opposite to those generated by element 31. These opposed currents, like discussed before can be used for propulsion purposes, or if the excitation is directional, were waves with fields in opposition are emitted in space, then masses on the propagation path will be subject to a directional force.

In order to create repulsion forces on masses 6, one could also use the setup depicted in FIG. 14.r), which uses several magnets 20 (with coils 14 around them) in opposition, and a chamber 30 containing a diamagnetic material 31. When coil(s) 14 around elements 20 are excited, element 31 (in liquid, gas, vapor or plasma form) will respond with opposing currents. Since that perturbation is propagating to the right, and will continue to propagate in space as opposed fields, any mass 6 on that path will be actuated with a force F.

If we want to use the arrangement of opposing magnets 20 (with coils 14 around them) as a propulsion unit (to be distributed around a spacecraft to vector propulsion) we can add a chamber 30 that contains an element 31 (with the properties described previously) like depicted in FIG. 14.s). Element 31 will respond with opposing currents to the magnets (and coils) thereby generating an antigravity force. Chamber 30 can have different geometries like depicted in FIGS. 14.s and 14.t) (not limiting), and the external excitation system (magnets 20 with coils 14) may vary in configuration (FIG. 14.u); not limiting). These are only examples, and applications are not limited to those shown. In all the embodiments of FIG. 14 and before, any coil 14, and/or 22, and/or 24, can be formed by a metal conducting coil, or a fiber optic coil, or a radiofrequency cable coil, or a microwave cable coil, or a coil material that permits a (conducting) plasma inside, or any other suitable conductor of electromagnetic energy.

Alternatively to magnetic forces we could also use opposing and non-opposing electrostatic forces (using positive or negative polarities, or the ground) for the same purpose. In FIG. 15 we can see how opposing and non opposing electric fields act on external masses. Opposing fields, shown in FIGS. 15.a) to 15.i), repel masses. In this case one can use parallel (perpendicular, or at any other angle) plates, concentric rings, or concentric electrodes (in solid, liquid, vapor, or plasma (ionized) state, where a containing chamber and electrical exciting means are used when necessary), having a symmetric or asymmetric shape (of flat, concave, conical, tubular, elliptical, circular, semi-circular or any other shape), charged (or ionized by any means) to the same polarity, and in relative rotation (FIGS. 15.h) and 15.i)) or not (FIGS. 15.a) to 15.g)). Electrodes 37 or 38 can be symmetric or asymmetric, that is, they can have equal or different dimensions (diameter, length, thickness, etc), were any combinations of shapes and dimensions can be used. Electrodes 37 or 38 can be (one or more layers of) concentric rings or electrodes of any shape (that close on themselves or not, that is, they are symmetric or asymmetric). One can use one electrode (or multiple concentric electrodes) inside a Faraday cage charged to the same high voltage polarity, or one can use one or more layers of concentric metallic enclosures (of any shape, or that close on themselves or not, that is, they are symmetric or asymmetric). Electrodes 37 or 38 can be superconductive or not, or even not conductive. In this last case the non-conductive material is charged, which will still respond to changing electrical fields with opposing currents. The spacing and thickness (or any dimension) of electrodes 37 or 38 can be of any scale, using a normal thickness or separation distance between the electrodes in the order of millimeters or centimeters (or more) or down to micrometers or smaller. Electrodes 37 or 38 can be parallel, perpendicular or at any angle to each other, or eventually form a grid of parallel or perpendicular planes (or planes at any other angle) that interconnect or not between themselves.

If one or more electrodes 37 or 38 are disposed in an asymmetric configuration like that in FIG. 15.e) and 15.f) (in one or more successive layers, or separated or not by non-conductive (dielectric materials with any dielectric constant) or semi-conductive, or any other elements which can also be the atmosphere or the vacuum), then a force will act on the setup itself as well as on any external masses. This happens because of the asymmetry of the mass distribution in relation to the area were the vacuum is stressed. Therefore, the setup shown in FIGS. 15.e) and 15.f) will be auto-propelled in the direction shown when charged at the same high voltage polarity (all positive or instead all negative, or instead all alternating or pulsed at the same time). The last drawing on the right of FIG. 15.f) is not auto-propelled. It represents the possibility of electrodes 37 or 38 being a chamber (of any shape) which contains an ionized material that is charged positive or instead is charged negative (since electrodes 37 or 38, and 35 or 36 can be in the solid, liquid, vapor, or in plasma (ionized) state; or any combination of physical states), which uses any type of confinement system (electrostatic confinement for example) and any electrical (or ionizing) exciting means (using electrodes inside the chamber or accelerating electric particles to the confinement area, for example) can be used when necessary. This concentration of charges of the same polarity exerts repulsive forces on nearby masses.

When electrodes 37 or 38 are charged to the same polarity (constant, pulsed or oscillating) and generate a gravitational repulsion, all electrodes can be permanently connected between themselves, or connected independently to the power source, or connected (or not connected) in any variation. A material with several (parallel, perpendicular or both) layers of conductive and non-conductive (or semi-conductive, or any) elements (which can also be the atmosphere or the vacuum) that are very near to each other (millimeters, micrometers or less), would be very effective at producing gravitational repulsion forces on nearby masses (FIG. 15.g)) when the conducting electrodes are charged to the same high voltage polarity (constant, pulsed or oscillating). If the spacing between the electrodes 37 (or 38), in FIGS. 15.e) and 15.f) (that have an asymmetrical shape and are auto-propelled), is very small (millimeters, micrometers or less) then it will increase the magnitude of the propulsive force generated.

Attracting fields, shown in FIGS. 15.j) to 15.m), attract masses. In this case one can use parallel (perpendicular or at any other angle) plates, concentric rings, or concentric electrodes (in solid, liquid, vapor or plasma state, where a containing chamber can be used when necessary), with any symmetric or asymmetric shape (flat, parabolic, concave, conical, tubular, elliptical, circular, semi-circular, or of any other shape), charged (or ionized) oppositely, or one polarity towards ground, and in relative rotation or not. Besides this, the other practical and operational considerations provided for the repulsion mode are also valid for the attraction mode, taking due care of the opposed polarity and inverse force between the electrodes.

Of special note is the use of rotation in opposite direction of the nearby plates or rings or ion clouds (in solid, liquid, vapor or plasma (ionized) state, where a containing chamber and electrical exciting means are used when necessary) 37 or 38, with velocity v, charged to the same potential (constant, pulsed or oscillating) like represented in FIG. 15.h). This will increase the repulsion between the plates because of the added repulsion between the oppositely directed currents (a magnetic repulsion component is added to the already existing electric repulsion component). If these charged plates (or rings) were rotating in the same sense they would transform the repulsion into an attraction (FIG. 15.k)). One can also use pulsed currents in both cases, were instead of a constant velocity v one can have an acceleration a, of the charges (with symmetric or asymmetric acceleration rising or falling times). In this case one would have to take care of the induction of opposing or attracting induced electric fields, E=−∂A/∂t, generated by the changing currents. In practice, we can accelerate or decelerate the plates directly, or else, we can make the rotation axis of one (or more) plate(s) eccentric (the axis of the motor is displaced from the geometric center of the rotating mass; plates, concentric rings, etc.) in such a way that, even if the applied force is constant, the plates are continuously accelerated one in relation to the other. However, as before, repulsing fields repel matter and attracting fields attract matter.

One could also use an electret material (with a single layer or multiple layers of opposite charges), or use the metallic plates or rings 35 and 36 (single pair or multiple parallel pairs, rings or layers), charged to opposite polarities (to a very high voltage, constant, pulsed or oscillating), with or without a dielectric (non-conducting) member, or semi-conducting member, (or any other member) interposed in between, that are rotated as a whole (or not) in the same direction with velocity v (FIG. 15.i)), in order to create a repulsion between the generated oppositely directed currents. This repulsion would create a tenser vacuum, increasing the negative gravity field of the vacuum in this area. Alternatively, electrodes or plates 35 and 36 (single pair or multiple parallel pairs, rings or layers), charged to opposite polarities, with or without a dielectric (non-conducting) member, or semi-conducting member, (or any other member) interposed in between, can be rotated in opposite senses with velocity v (FIG. 15.l)), in order to induce attraction between the generated currents, and therefore a gravitational attraction of nearby masses.

As before, one can also use pulsed currents were instead of a constant velocity v one can have an acceleration a, of the charges (with symmetric or asymmetric rising or falling times). In this case one would have to take care of the induction of opposing or attracting induced electric fields, E=−∂A/∂t, generated by the changing currents. In practice, we can accelerate or decelerate the plates directly, or else, we can make the rotation axis of one (or more) plate(s) eccentric (the axis of the motor is displaced from the geometric center of the rotating mass; plates, concentric rings, etc.) in such a way that, even if the applied force is constant, the plates are continuously accelerated one in relation to the other. However, like before, repulsing fields repel matter and attracting fields attract matter.

Although represented symmetrically, the parallel plates 37 or 38 (or 35 and 36) can be asymmetric, that is, have different relative dimensions; and may be flat, concave, conical or any other shape. The represented parallel plates 37 or 38 (or 35 and 36) can also be (multiple) concentric rings (stationary or rotating), that can be superconductive or not, or even not conductive (but electrostatically charged), or can form a single pair or multiple parallel pairs (or electrodes), with or without a dielectric (non-conducting, semi-conducting or any other material) member interposed in between.

If we repeated the Galileo dropping experiment with two (or multiple) parallel conductors 37 or 38 charged to the same (high voltage) polarity (constant, pulsed or oscillating), we would also observe a slower fall (FIG. 16.a)). This would happen because the conductors are charged to the same polarity and therefore the electric field between them would be in opposition, increasing, the vacuum stress in that area, thereby repelling also the planet.

For propulsion purposes we can surround a mass by parallel conductive plates that can be charged to any constant, pulsed or oscillating polarity (FIG. 16). In particular, if we have conductive plates 37 or 38 at one extremity and conductive plates 35 and 36 at the other extremity, and we charge plates 37 (or 38) with the same charge, and charge (or not charge) plates 35 and 36 with opposite charges, the mass will feel a force towards the lower vacuum stress (away from the plates with the same charge and towards the plates with opposite charges) as shown in FIGS. 16.b) to 16.j). Since there is no danger of disruption between the plates charged at the same polarity we can charge them to millions of volts without electrical disruption. But since the plates 37 or 38 may also be used to be charged with opposite charges (like plates 35 and 36), we can encapsulate all (multiple) plates or rings in a dielectric material or a non-conducting material, with the advantage of increasing mechanical strength, stability and security. The vacuum stress induced by the electric forces would induce propulsion forces on surrounding masses as discussed also in relation to FIG. 15.

Instead of parallel plates we could use a Faraday cage for the same purpose. Charging a metallic enclosure to millions of volts (DC, AC, pulsed) would have the same effect of using two parallel plates that are charged with the same charge because the electric field is zero summed inside. Alternatively, one could introduce one electrode 35 inside the Faraday cage 36. In the attractive mode, the interior electrode 35 would be charged to whatever voltage and the exterior electrode 36 would be charged neutral in order to maintain exterior electric neutrality (FIGS. 16.g) to 16.i), where 39 represents the application of a radiofrequency to electrode 35), or inversely, we could charge the external electrode 36 and maintain electrode 35 neutral. This arrangement functions in the repulsive mode if the charges are equal (FIG. 16.e) and 16.f)) or in the attractive mode if the applied charges on each electrode are opposite or even if the external enclosure is maintained at ground potential and the inner electrode is charged plus (FIG. 16.g)), minus (FIG. 16.h)) or submitted to a pulsed or AC radiofrequency (RF) 39 (FIG. 16.i)). Please note that the parallel plates 37 or 38 that are in repulsion mode (FIGS. 16.b) to 16.f)) can be excited by high voltage DC (direct current), high voltage AC (alternating current), or pulsed current (any waveform).

Alternatively, in accordance with the explanation given to FIG. 3.c), a high density plasma 8 can be used to induce an attractive force towards it (FIG. 16.k)). This force will increase with the plasma density produced (plasma density and thickness have to be optimized like described by Laroussi and Anderson (1998), for example). This plasma may be formed using one or more electrodes (or coils, or electromagnetic antennas in any combination and of any shape and form), inside (or at the periphery) a chamber 40 (spherical, rectangular or any other shape; made of transparent metal or any other, conducting, non-conducting, semi-conducting or any other material), that are excited by a power source in order to form a solid state plasma (an ionized solid material), a liquid, a vapor or a gaseous plasma (at high pressure, for example), or using any adequate substance inside chamber 40 that can be ionized to form that plasma 8 (FIG. 16.k)). Besides the chamber 40 to contain the plasma, any other already known means to contain the plasma 8 can be used (electrostatic or magnetic confinement for example). If plasma 8 is solid state, then chamber 40 might not be needed.

The parallel metallic electrodes 37 or 38 (or 35 and 36) represented in the different setups of FIGS. 15 and 16 can be of any number as exemplified by the parallel plates 41 represented by the side view in FIG. 17.a). Although they are represented has symmetric they can also be asymmetric (have different dimensions in relation to the other electrodes). The plates 41 (37 or 38, or 35 and 36) can also be separated into different and independent sections in order to vector propulsion, like exemplified in the upper view in FIG. 17.b). These independent sections are a short distance separated in order to really function independently, and the whole setup may be encapsulated in a non-conducting (dielectric) material, semi-conducting or any other material.

Electric longitudinal waves can also be used for propulsion. Monstein and Wesley (2002) have verified experimentally the existence of longitudinal electrodynamic waves. These are waves where the electric field 42 oscillates along the propagation axis and not perpendicularly as usual. As they say in their article, a spherical symmetrical electrode 43 can only propagate longitudinal waves (FIG. 18.a)). Other shapes can radiate both types of electric field (longitudinal and transversal). Since other shapes can also emit longitudinal waves they are shown as illustrative useful examples (not limiting) in FIGS. 18.b) to 18.e). FIG. 18.b) shows an oval shape, FIG. 18.c) is a toxoid shape, FIG. 18.d) is a rectangle shape, and FIG. 18.e) is a concave shape of a conducting material 45. In these figures, elements 43 and/or 45 are exposed to the surrounding environment or may be involved by a protective enclosure 44 made of non-conductive (dielectric) material, or semi-conductive material or any material, and whose shape can be similar or different to the shape of elements 43 and/or 45. If used, the protective enclosure 44 can be molded (or not) to the shape of elements 43 and/or 45, or instead can allow the presence of a separating space or chamber (between the enclosure 44 and elements 43 and/or 45), that can be filled with a solid or liquid (non-conductive dielectric or semi-conductive), material for protective purposes (avoid plasma formation), or that can be filled with a liquid, vapor or gaseous material for the purpose of plasma creation if desired (a material that can be ionized). For example, if the enclosure 44 allows the existence of a space that can be filled with a gas, then it can be ionized and form a plasma 8 if the conductor 45 is excited by AC or pulsed current (high voltage) (FIG. 18.f)), and this plasma can also be used to generate longitudinal waves, functioning as a plasma antenna (Jenn, 2003).

A longitudinal interference zone in space can be formed by the excitation with a power source of two or more nearby elements 43 and/or 45, in proximity (that face each other, or not), with or without the enclosure 44 (and with or without a plasma inside the enclosure). But the conductor 45 can also be passive (not excited directly by a power source) and used only to reflect incoming waves from elements 43 as shown in FIGS. 18.g) to 18.i). In these figures the electrode 43 is, placed below element 45, and is excited by an AC or pulsed (high) voltage. The longitudinal waves generated by these electrodes 43 (any number may be used) are reflected by the passive conducting element 45 in order to form a directed propagation path or beam of longitudinal waves. In FIG. 18.g) electrode 43 as the shape of a ring or torus (or may be two spheres or may even have any other shape as exemplified by FIGS. 18.a) to 18.e), but not limited to those). In FIG. 18.h) electrode 43 has a spherical shape, and in FIG. 18.i) we can see how an electrode 43 placed at the focus point of a parabolic reflector generates a directed beam of longitudinal waves in the direction of the represented arrows. This last setup in FIG. 18.i) (electrode(s) 43 and parabolic reflector 45) constitutes the longitudinal beam emitter 46. In this case, reflecting element 45 can be passive (not connected to a power source), or charged to a static (or changing) high voltage (any polarity), or connected to any given power source. Element 45 is formed by any conductive metal, that may have any shape, or may be a plasma reflector.

We can also charge element(s) 43 and/or 45 with static (pulsed or oscillating) high voltage and produce longitudinal waves by mechanically vibrating element(s) 43 and/or 45. In this way it is possible to emit longitudinal waves in space that interfere in order to create one or more attraction or repulsion points in space. Alternatively we can charge element(s) 43 with a static (pulsed or oscillating) high voltage, and generate longitudinal waves by mechanically vibrating element(s) 43, which is placed at the focus point (or simply below) of a parabolic (or a reflector with any other shape, flat or semi-circle for example) reflector 45 (connected or not to a power source), that may be charged or not with a static (or changing) high voltage. The parabolic reflector 45 can also be charged with static (or changing) high voltage and mechanically vibrated in order to generate longitudinal waves that can also create directly a focus point in space (FIG. 19.j), where 52 represents an interference zone) that can repel or attract matter (and the reflector itself).

FIG. 19.a) shows the variation in time (or a projection in space) of the longitudinal electric field intensity 42 and direction or vector 47, emitted by electrode 43 or 45 or by the beam in FIG. 18.i), emitted by element 46. Considering that this represents the projection of the electric field vectors 47 in space of the longitudinal electric field 42, we can see areas were the electric field vectors are in opposition and others were they are not. We had concluded from FIG. 1 that electric charges with opposed electric field vectors increase the vacuum density between them, thereby creating a repulsion force from that zone. And the non-opposed (or attracting) electric fields decreased the vacuum density creating an attraction force towards that area. This theory also applies to the electric field vectors 47 generated by propagating longitudinal waves. The repulsion points 48 (FIG. 19.a)) are located were the electric field vectors are in opposition, and the attraction points 49 are located were the electric field vectors are not in opposition. FIG. 19.a) also shows that any mass 6 acted by these forces will tend to be transported towards the attraction points 49.

If two longitudinal beam emitters (FIG. 19.b)) are positioned face to face, and if they are excited by a frequency that allows for a standing wave pattern (that can change in time or not, but which maintains the same field relation, in opposition or attraction) to be formed along their axis of separation, then we will have one or more attraction and/or repulsion points, 49 and 48 respectively, along this axis. Therefore a mass subjected to these forces can be levitated, transported and moved by varying the phase 50 of the longitudinal standing wave pattern (by changing the phase of the exciting frequency(ies) or of the modulation of this frequency(ies); the use of equal or similar frequencies facilitates the process of phase synchronization).

Alternatively, we can use only one (or more) beam emitter(s) 46, as shown in FIG. 19.c), and/or one (or more) longitudinal wave emitter(s) (43) and/or (45) (element (45) can be a plasma antenna or not). If the phase 50 of the emitted wave (or of the resultant wave from the interference of more than one source) changes (or propagates in space) continually in one direction, in order to form a traveling wave in space, then it can be used has an attractive or repelling wave (in all directions, like the repulsion from the epicenter of an explosion due to the propagating pressure wave if we use element 43 or 45), or instead can be used has an attractive or repelling focused beam, were the attraction and/or repulsion depends on the direction of the phase change (any mass will be dragged by the moving attracting/repelling points in the direction they propagate) of the propagating wave or beam in space (by directly changing the phase 50 of the emitted wave or beam, for example). Considering FIG. 19.c), if the phase propagates from the beam emitter 46 to the right, then it will function as a repelling beam on a nearby mass in that direction. If the phase propagates from the right towards the beam emitter 46, then it will function as an attractor beam on that mass. This happens because any mass subjected to this beam will be “locked” at the attracting points 49 because it is being repelled from repulsion points 48. If these attracting and repelling points move in space, then the mass will follow in the same direction. A system like this can be used for propulsion, or to manipulate masses at a distance (or also the mass that carries the generating elements 43, and/or 45, and/or 46), and eventually also to extinguishing fires at a distance.

If we have a metallic conductor 51 (that can be passive: reflecting, or active: longitudinal wave emitting), that is flat (concave or of any other shape), facing the longitudinal beam emitter 46, or the longitudinal wave emitter 43 and/or 45, it will reflect (passive behavior) the incoming longitudinal waves and create an interference pattern between incoming and reflected longitudinal waves. This process may generate a standing wave pattern has represented in FIG. 19.d). Along this standing wave there will be several stationary attraction points 49 and repelling points 48 on which masses can be suspended. Element 51 can be moved or not, charged or not with static (pulsed or oscillating) high (or low) voltage or also excited or not by a power source, in order to generate a standing or changing wave pattern. One can vary the phase of the mentioned longitudinal standing wave pattern (by moving element 46, and/or 51, and/or 43, and/or 45, or by changing the phase of the exciting frequency(ies) or the phase of the modulation of this frequency(ies)) in order to transport, levitate or move a mass (including also the mass of the generating elements 43, and/or 45 and/or 46, and/or 51).

In FIG. 19.e) a concave metallic conductor 51 is used (any shape can be used) which also reflects the incoming longitudinal waves and creates an interference pattern. Since the shape is parabolic (concave, or any other shape), it may create a stronger focus point on an interference zone 52 at short distance, that can be used to create forces on nearby masses, including the reflecting plate 51 also.

In FIG. 19.f) we have two longitudinal beam emitters 46 that create a repelling focus point 48 in space from the interference of two (or more) wave patterns at a distance. This system can be used to manipulate masses at a distance. If these emitters are mounted on an aircraft, then the mass 6 of the craft will be repelled from this point and will be propelled upwards (FIG. 19.g)). Any number of beam emitters 46 can be used. Using two (or three) beam emitters that create a focus in the downward direction, and another two (or three) beams that create a different focus (attractive or repulsive) upwards (FIG. 19.h)) will allow for a better propulsion control.

Alternatively, one can use more than one electrode 43 near the passive conductor 45, like shown in FIG. 19.i). Using two or more electrodes 43, like shown, will also create an interference area 52 below element 45 which can induce propulsive forces (on elements 43 and 45) as discussed before. Or we may use two or more electrodes 43 that interfere between themselves (without using any outside element 45 above or below electrodes 43), in order to create an interference pattern in space and induce propulsion forces as discussed above. In another embodiment, conductor 45 can be directly excited by a power source, in order to create an interference zone 52 (or a focus) as shown in FIG. 19.j). In all cases, besides normal excitation using AC or pulsed generators (Tesla coils tuned to pulsed or AC mode, for example), one can also use an excitation developed by the Avramenko's (2000) (which can be used in all former embodiments).

Another way to create an interference zone for the purposes discussed before is the use of an acoustic lens 53 that can be, for example (but not limiting), a zone plate in order to focus the longitudinal waves from element 43 (or 45 or 46) in an interference zone 52 (FIG. 19.k) and 19.m)). Zone plates function like an acoustic lens 53, and are made of several metal concentric rings (FIG. 19.l)) and are used in the field of acoustics (Everest, 2001) as acoustic lens, in order to focus sound on a specific point. The slits in the zone plate 53 are arranged so that the several path lengths differ by multiples of a half wavelength of the longitudinal wave propagated, so that all diffracted rays arrive at the focal point in phase, combining constructively. This setup can also function as an acoustic lens for electrodynamic longitudinal waves (FIG. 19.k) and 19.m)). Element 53 can be any type of acoustic lens that is known. One can use more than one setup like that represented in FIG. 19.k) or 19.m) in order to create a stronger focal point. One or more zone plates can be used as an acoustic lens 53 for electrodynamic longitudinal waves in order to create a focal point for the longitudinal waves emitted by elements (or emitters) 43, and/or 45, and/or 46, and/or 51. The focus of this lens can create a repelling point 48 or an attracting point 49 for mass manipulation or propulsion purposes as before.

In order to illustrate some non-limiting applications of the propulsion units (54) discussed above (in FIGS. 4 to 19, using magnetic or electric forces) we illustrate some concepts in FIG. 20. There can be a uniform distribution of propulsion units around the periphery of the craft (with mass 6) in order to vector propulsion as illustrated in FIG. 20.a). FIGS. 20.b) and 20.c) illustrate a top or bottom view of FIG. 20.a) with more propulsion units to vector propulsion. When traveling, these propulsion units 54 can be used to repel the atmosphere while on a planet, to avoid friction losses, or to repel space debris (for safety) when traveling in space. FIGS. 20.d) and 20.e) illustrate some different shapes. There can be used any shape whatsoever for the vessel or mass 6. The only important factor is the use of several propulsion units 54 to vector propulsion. Besides these propulsion units 54, the craft can have a general global and symmetric system that generates antigravity forces, like illustrated in FIGS. 12 and 13, that can be excited asymmetrically (in sections) or were propulsion units 54 are used to vector propulsion.

Since any mass can be attracted or repelled with this system, we can use it to manipulate masses, extinguish fires, or achieve propulsion (aerial, terrestrial, underwater or space propulsion), levitation or suspension. FIG. 21.a) illustrates another conceptual use where (animated or non animated) masses are suspended inside (or in any other adequate space) a chamber (active zone) for recreation purposes or scientific research. The upper 55 and/or lower 56 sections (and/or side sections) of the chamber contain propulsion units 54 and can produce repulsive or attractive forces on the masses 6 inside the chamber in order to induce weightlessness or directed movements. These can be produced by all propulsion units 54 discussed above using magnetic or electric forces to polarize the vacuum, and are contained in sections 55, and/or 56, and/or in any lateral section, were any section can function independently of one another.

The propulsion units 54 can also be used to produce energy, as exemplified in FIGS. 21.b) to 21.e). Because the propulsion units repel or attract any mass 6, then if we place one propulsion unit 54 in physical contact with a mass 6 the setup would move as discussed before. If we hook up physically one or more of these setups (mass 6 and propulsion unit 54) to an axis 58 through a connecting arm 57, as illustrated in FIG. 21.b), in such a way that a binary of force is produced, then the axis 58 will rotate with rotational velocity 59. This system can produce energy if the axis 58 transmits its rotational velocity (or torque) to a normal electric generator, like that used for example in wind or hydroelectric electric system generators (not represented). If the propulsion units are asymmetric, then they will be auto-propelled and it won't be necessary to use of an additional external mass 6 (FIG. 21.c)), in order to achieve the same effect. On the other hand, the propulsion units don't need to be in physical contact with mass 6 that will be displaced (FIG. 21.d)). Since we can use any number of propulsion units 54, that can function in attractive or repulsive mode (FIG. 21.d), where 60 represents a vertical support for the axis 58, and 61 represents a support surface, that can support the setup including the propulsion units 54. Mass 6 can have any shape or geometry, including a ring as represented in FIG. 21.e). Since we can use any number of propulsion units 54 to induce a rotation of mass 6 around the axis 58, we can eventually use only one propulsion unit 54 in order to produce repulsive forces on a part of the ring mass 6 (or in separate and independent masses like in previous figures), were one of the sides (left, for example) is subject to a repulsive force and the other (right) side is subject to an attractive force due to the natural gravity force of Earth 7 that is bellow surface 61. In this way (FIG. 21.e) in this possible to generate a rotation of mass 6 around axis 58 and produce energy as discussed before. The efficiency of energy production will depend on the power consumed by the propulsion units 54. Although we can use any propulsion unit 54 with any power source, it would be preferable the use of constant voltages in the appropriate propulsion units, due to the fact that they are able to consume less power.

It should be mentioned one secondary effect or important alternative use of opposing and attracting magnetic or electric fields related to radioactive elements. It is known that in specific conditions, the radioactive decay may be induced to increase and thereby become stronger. This process will deplete the radioactive process at a faster pace depending on the vacuum stress at the location of the radioactive element. In this manner it is possible to shorten the radioactive decay lifetime from hundreds of years to weeks or days. A first experimental indication for this process occurred with the work of Reich (1951). He introduced radioactive elements inside an orgone accumulator which is nothing more than a closed capacitor with several concentric parallel plates, separated by a non-conducting material (and not connected to any electromagnetic source). Unexpectedly, the radioactive power of the elements became much stronger inducing ill effects on the health of his staff. Therefore the setup was disassembled, but only months later did they found that these radioactive elements had lost their radioactive energy.

It is easy to explain what happened at this unfortunate incident. Just like in the Casimir effect where two conducting plates decrease the vacuum density between them, leading to a vacuum force pushing the plates together, the capacitor or multiple metallic plates (concentric Faraday cages) in close proximity achieved a similar (but smaller) decrease in the vacuum density. Since the vacuum density (tension) decreased, it lead to an increase in emitted power and faster depletion of the radioactive energy.

A vacuum density (tension) decrease can be accomplished in various ways as discussed before. Therefore it is intended to use the aforementioned processes to decrease or increase the vacuum density (tension) to control the speed of radioactive decay with applications to nuclear batteries or power sources which are more reliable, allowing the increase or decrease of the radioactive power output when needed. Another important application, of this process would be for cleaning the radioactive waste of nuclear energy production, by depleting the radioactive element at a faster pace. In this way, radioactive waste with lifetimes of thousands of years can have that time reduced significantly.

Submitting opposing electric or magnetic fields (vacuum density and tension increases) on radioactive elements 62 should stabilize and prolong the lifetime of these elements. If the fields are attracting (vacuum density and tension decreases) they should speed up the radioactive elements decay, releasing temporarily more power. FIG. 22 shows several application examples (not limited to those shown), where the radioactive element 62 is placed at electric or magnetic, attraction or repulsion points, according to the desire to increase depletion or stabilize the radioactive element.

FIG. 22.a) to 22.d) shows radioactive element 62 inside a Faraday cage which can have multiple concentric electrodes 35 and 36 charged to equal polarities, opposite polarities, or one electrode to the ground and the other to a source of radiofrequency (RF) 39. Element 63 is a dielectric element (non-conductor, semiconductor, or any other material) that is gaseous, liquid or solid (or a mixture of each). In FIG. 22.d) instead of element 63, we have element 64 that can be easily ionized by a power source in order to form a plasma surrounding electrode 35 and radioactive element 62, in order to decrease the surrounding vacuum tension. In FIG. 22.d) electrode 35 is connected to a radiofrequency source 39 (coils or electromagnetic antennas, or any other electromagnetic excitation source), connected to the appropriate power source, in such a way to generate a plasma 8 between electrodes 35 and 36 (were the radioactive element 62 is inside electrode 35), with the purpose of diminishing the vacuum tension around element 62. In an alternative form, it is possible to place radioactive element 62 inside a chamber 40 of any material, and that contains (or is surrounded by) element 64, were element 62 could be protected by a second chamber 40 inside the first. Element 64 would be also ionized as described before and for the same purpose. FIG. 22. e) shows the radioactive element 62 placed between parallel plates that are attracting or repelling. Radioactive element 62 can also be placed at the attracting or repelling points formed by the longitudinal beam emitter(s) 46 (and/or 43, and/or 45, and/or 51), or one can use an element 43 (and/or 45, and/or 46, and/or 51) together with an acoustic lens 53 (a zone plate, for example), like shown in FIGS. 22.f), 22.g) and 22.h). Furthermore, magnetic forces can also be used has shown in FIGS. 22.i) and 22.j), where the coils 14, that surround magnets 20, can be used and excited by DC, AC, or pulsed currents. There are much more possibilities according to all the previous techniques used for antigravity propulsion that create a point in space with opposed or attracting fields and that can be used for this purpose also.
Avramenko, S., and Avramenko, K., “Method and apparatus for single line electrical transmission,” U.S. Pat. No. 6,104,107, 2000.
Bushman, B. B., “Apparatus and method for amplifying a magnetic beam,” U.S. Pat. No. 5,929,732A, 1999.
Everest, F. A., The Master Handbook of Acoustics, 4^{th} edition, McGraw-Hill, 2001.
Glanz, J., “Astronomers see a Cosmic Antigravity force at work,” Science, 279 (5355), pp. 1298-1299, 27 Feb. 1998.

Grön, Ø., “Repulsive gravitation and inflationary universe models,” American Journal of Physics, 54 (1), pp. 46-52, 1986.
Grön, Ø., Lecture notes on the general theory of relativity: From Newton's attractive gravity to the repulsive gravity of the vacuum, Springer, 2009.
Grön, Ø., and Hervik, S., Einstein's general theory of relativity—with modern applications in cosmology, Springer, 2007.
Jenn, D. C., “Plasma antennas: Survey of techniques and the current state of the art,” NPS-CRC-03-001, Naval Postgraduate School, California, 2003.
Kohno and Yao, “Anomalous sound attenuation in the metal-nonmetal transition range of liquid mercury,” J. Phys.: Condens. Matter, 11, pp. 5399-5413, 1999.
Lamoreaux, S. K., “Demonstration of the Casimir force in the 0.6 to 6 μm range,” Phys. Rev. Lett., 78 (5), pp. 5-8, 1997.
Laroussi, M., and Anderson, W. T., “Attenuation of electromagnetic waves by a plasma layer at atmospheric pressure,” International Journal of Infrared and Millimeter Waves, 19 (3), pp. 453-464, 1998.
Magueijo, J., Faster than the speed of light, Perseus Publishing, 2003.

Maxwell, J. C., “On Physical Lines of Force, Part I: The theory of molecular vortices applied to magnetic phenomena,” Philosophical Magazine and Journal of Science, 21 No. 139, 161-175, March 1861.
Monstein, C., and Wesley, J. P., “Observation of scalar longitudinal electrodynamic waves,” Europhysics Letters, 59 (4), pp. 514-520, 2002.
Reich, W., The Oranur experiment, Orgone energy Press, 1951.
Lisbon, 22 Jun. 2009

1. Device for vacuum manipulation (antigravity propulsion through the repulsion or attraction of a mass like planet Earth or a general mass), characterized by a geometric (or not geometric) arrangement of at least one pair (two magnets or any other number) of magnets with the north pole or the south pole in opposition (disposed in the same parallel plane, or at a perpendicular plane, or at any desired angle or angles); or were the magnets are arranged symmetrically (circular, hexagonal or any other) or asymmetrically (semicircular, conic, pyramidal, or any other); or by the magnets being disposed in a way to oppose the magnetic vector potential component (with magnetic poles face to face, or side to side, or at any other angle) in order to stress the vacuum and create a gravitational repulsive force on nearby masses (if the mentioned magnets are disposed with the magnetic vector potentials in attraction, with their vectors in the same direction, then they would generate an attractive gravitational force instead); or by the possibility of using a grid of multiple repelling (or attracting) magnets with (or without) coil or coils wrapped around them (each magnet or the whole or partial assembly of magnets); or by one or more magnets being wrapped by one or more coils.

2.-79. (canceled)
